(19) United States
(12) Patent Application Publication
(10) Pub. No.: US 2005/0027557 A1
(43) Pub. Date: Feb. 3, 2005

(54) Content distributing system, content distributing method, content distributing server, and terminal unit

(76) Inventors: Takashi Kawakami, Tokyo (JP); Manabu Kii, Tokyo (JP)

Correspondence Address: FROMMER LAWRENCE & HAUG LLP, 745 FIFTH AVENUE, NEW YORK, NY, 10151, US

(21) Appl. No.: 10/902,187

(22) Filed: Jul. 28, 2004

(30) Foreign Application Priority Data
Jul. 31, 2003 (JP) P2003-283534

(51) Int. Cl. G06F 17/60

(52) U.S. Cl. 705/1

(57) ABSTRACT

A service body comprises a right server, a content server, and a buddy server. The right server correlatively manages charging information and a unique disc ID of each disc. The content server manages a content that is distributed and information associated therewith. The buddy server correlatively manages a disc ID of an information provider side and a disc ID of an information recipient side. A user loads a disc he or she bought from the service body into a disc drive device, logs in the content distributing server, and obtains information corresponding to the disc ID.

### BACKGROUND OF THE INVENTION

1. Field of the Invention

The present invention relates to a content distributing system, a content distributing method, a content distributing server, and a terminal unit.

2. Description of the Related Art

In recent years, in the field of a portable recoding and reproducing apparatus that records and reproduces music and so forth, a portable model that has a hard disc drive and is structured in a very small size has come out. Music data recorded in such a portable recording and reproducing apparatus is controlled by a personal computer connected thereto.

For example, a lot of music data is recorded in the hard disk drive of the personal computer and a library thereof is formed so that the personal computer works as a music server. Music data is normally ripped from a compact disc (CD) or downloaded from a network such as the Internet using a music distributing system that operates thereon.

Music data of the library stored in the personal computer is transferred to the portable recording and reproducing apparatus that is connected thereto through a cable. The portable recording and reproducing apparatus records the transferred music data in the internal hard disk drive. The user can enjoy listening to music data of the library recorded in the hard disk drive of the portable recording and reproducing apparatus at his or her favorite placed for example outdoors.

To improve music listening environment, many proposals have been made. For example, the following patent related art reference 1 describes a music information providing system and a method thereof that allow a user to easily download music data from a network. In the music information providing system described in the patent related art reference 1, when the user connects a terminal unit to a portal site, he or she can get music data that the portal site has. The portable site manages a particular community site. As an example of functions that the user can use for the portal site, there is a group mail function of which users of the same group can exchange their opinions and impressions. The related art reference describes that membership of each user of each group is automatically decided in accordance with stored purchase and use history information.

[Patent Related Art Reference 1]

Japanese Patent Laid-Open Publication No. 2003-15665

On the other hand, as a recording medium to and from which digital audio data is recorded and reproduced, a Mini Disc (MD) that is a magneto-optical disc having a diameter of 64 mm has been widely used. In the MD system, as a compression system for audio data, Adaptive Transform Acoustic Coding (ATRAC) system has been used. Music data is managed in accordance with user table of contents (U-TOC). A region of the U-TOC is placed on an inner periphery of a recordable area of the disc. In the conventional MD system, the U-TOC is management information that is rewritten in accordance with the order of tracks (audio tracks/data tracks) and they are recorded and erased. The U-TOC serves to manage the start position, end position, and mode of each track (or a part that composes a track).

Since the MD system uses such a file managing system that is different from a file system based on the file allocation table (FAT) that is generally used in a personal computer, the former does not have compatibility with a general-purpose computer such as a personal computer. Thus, to allow the MD system to have compatibility with a personal computer, a system that has a general-purpose managing system, such as the FAT system, has been proposed.

A portable recording and reproducing apparatus that uses a recording medium having compatibility with a personal computer may be connected to a music server that uses the foregoing personal computer. A library recorded in the music server may be recorded to a disc.

Although the recording capacity of a disc of the conventional MD system is around 160 MB, when a disc that has compatibility with the conventional MD and that has an increased recording capacity is used, it is expected that a function similar to the foregoing portable recording and reproducing apparatus having a hard disk drive can be accomplished. To increase the recording capacity of a disc of the conventional MD system, it is necessary to improve the wavelength of a laser and the numerical aperture NA of an optical head. However, the improvement of the wavelength of a laser and the numerical aperture NA of an optical head is restricted. To break such restriction, a system that has a large recording capacity using a technology such as magnetic ultra resolution has been proposed.

However, when the foregoing conventional music content distributing system is used, the user often needs to register his or her name, address, and so forth to the distributing system. When the user wants to use the content distributing server, he or she should perform a log-in operation. Thus, the user cannot easily use the system.

In addition, when the user uses the conventional music content distributing system, only the music content distributing side uses purchase and use history of the user's music content. If the user dubs his or her recommended song and gives the dubbed song to another person such as his or her friend, although he or she may contribute to popularization of the song, the copyright law prescribes that his deed will violate copyright of the copyright owner. In addition, it is difficult for another user who receives a song to select his or her favorite song. Thus, it was difficult to structure an environment that allows music content purchase and use history of one user to be securely supplied to another user.

### OBJECTS AND SUMMARY OF THE INVENTION

Therefore, an object of the present invention is to provide a content distributing system, a content distributing method, a content distributing server, and a terminal unit that allow an environment of which a user can comfortably distribute a content and popularize the content to be structured.

To solve the foregoing problem, a first aspect of the present invention is a content distributing system for distributing a content from a content distributing server to a terminal unit, wherein the terminal unit is configured to obtain a recording medium identifier from a recording medium, the recording medium identifier being unique to each recording medium, and wherein the content distributing server comprises: managing portion for correlatively managing charging information and the recoding medium identifier of each recording medium; a registering portion for correlatively registering a first recording medium identifier identifying a recording medium of an information provider side and a second recoding medium identifier identifying a recording medium of an information recipient side; a content distributing portion for distributing a content to the terminal unit and updating the charging information; and a recording portion for correlatively recording the recording medium identifier used to connect the terminal unit and the content distributing server and history information of the content that has been distributed by the content distributing portion, wherein when the recording medium identifier that is used to connect the terminal unit and the content distributing server is the second recording medium identifier, the content distributing server provides the history information corresponding to the first recording medium identifier correlated with the second recording medium identifier to the terminal unit.

A second aspect of the present invention is a content distributing server for distributing a content to a terminal unit, comprising: a managing portion for correlatively managing charging information and a recoding medium identifier of each recording medium; a registering portion for correlatively registering a first recording medium identifier identifying a recording medium of an information provider side and a second recoding medium identifier identifying-a recording medium of an information recipient side; a connecting portion for connecting the terminal unit to the content distributing server with a recording medium identifier obtained from a recording medium by the terminal unit; a content distributing portion for distributing a content to the terminal unit and updating charging information; and a recording portion for correlatively recording the recording medium identifier used by the connecting portion and history information of the content that has been distributed by the content distributing portion, wherein when the recording medium identifier used by the connecting portion is the second recording medium identifier, the history information corresponding to the first recording medium identifier correlated with the second recording medium identifier by the registering portion to the terminal unit.

A third aspect of the present invention is a terminal unit for receiving a content from a content distributing server, comprising: a connecting portion for obtaining a recording medium identifier from a recording medium and connecting the terminal unit to the content distributing server with the obtained recording medium identifier, the recording medium identifier being unique to each recording medium, wherein information about the recording medium identifier is received from the content distributing server.

In the content distributing system according to the present invention, the terminal unit can be connected to the content distributing server using a recording medium identifier obtained by the terminal unit. Thus, even if user information is not registered, the terminal unit and the content distributing system can be easily connected. The content distributing server pre-records the first recording medium identifier and the second recording medium identifier that have been correlated. The content distributing server pre-registers the content distribution history information correlated with the recording medium identifier that is used when the terminal unit is connected to the content distributing server. When the recording medium identifier that is used when the terminal unit is connected to the content distributing server is the second recording medium identifier, the content distributing server supplies history information corresponding to the first recording medium identifier correlated with the second recording medium identifier correlated by the registering portion to the terminal unit. As a result, the information recipient side can securely obtain information of a content distributed to the information provider side.

In addition, in the content distributing system according to the present invention, since the terminal unit is connected to the server using the recording medium identifier obtained by the terminal unit. Thus, even if user information has not been registered, the terminal unit can be connected to the server. The content distributing server pre-records the first recording medium identifier and the second recording medium identifier that have been correlated. The content distributing server pre-registers the content distribution history information correlated with the recording medium identifier that is used when the terminal unit is connected to the content distributing server. When the recording medium identifier that is used when the terminal unit is connected to the content distributing server is the second recording medium identifier, the content distributing server supplies history information corresponding to the first recording medium identifier correlated with the second recording medium identifier correlated by the registering portion to the terminal unit. As a result, the information recipient side can securely obtain information of a content distributed to the information provider side.

In addition, in the terminal unit according to the present invention, since the recording medium identifier is obtained from the recording medium and the terminal unit is connected to the content distributing server using the obtained recording medium identifier, even if user information has not been registered, the terminal unit can be connected to the content distributing server. Since information of the recording medium identifier is received from the content distributing server, information of a content can be securely obtained.

According to the present invention, since a content distributing service can be performed without need to register user information such as user's address and name, he or she can easily use the system without need to consider a risk of which information leaks out from the system. In addition, since information of a content distributed to the information provider side can be securely supplied to the information recipient side, information of a content can be easily exchanged between users.

Thus, the content distributing system, the content distributing method, the content distributing server, and the terminal unit according to the present invention allow a content to be comfortably distributed to a user. In addition, an environment of which a content can be popularized can be structured.

These and other objects, features and advantages of the present invention will become more apparent in light of the following detailed description of a best mode embodiment thereof, as illustrated in the accompanying drawings.

### BRIEF DESCRIPTION OF THE DRAWINGS

The invention will become more fully understood from the following detailed description, taken in conjunction with the accompanying drawings, wherein like reference numerals denote like elements, in which:

FIG. 1 is a schematic diagram describing a disc corresponding to specifications of a next generation MD1 system;

FIG. 2 is a schematic diagram describing a recording area of the disc according to the specifications of the next generation MD1 system;

FIG. 3A and FIG. 3B are schematic diagrams describing the disc according to the specifications of the next generation MD1 system;

FIG. 4 is a schematic diagram describing a recording area of a disc according to specifications of a next generation MD2 system.

FIG. 5 is a schematic diagram showing an example of a format of a UID;

FIG. 6 is a schematic diagram describing an error correction code encoding process for the next generation MD1 and the next generation MD2;

FIG. 7 is a schematic diagram describing the error correction code encoding process for the next generation MD1 and the next generation MD2;

FIG. 8 is a schematic diagram describing the error correction code encoding process for the next generation MD1 and the next generation MD2;

FIG. 9 is a perspective view describing generation of an address signal using wobbled grooves;

FIG. 10 is a schematic diagram describing an ADIP signal of the conventional MD system and the next generation MD1 system;

FIG. 11 is a schematic diagram describing the ADIP signal of the conventional MD system and the next generation MD1 system;

FIG. 12 is a schematic diagram describing the ADIP signal of the next generation MD2 system;

FIG. 13 is a schematic diagram describing the ADIP signal of the next generation MD2 system;

FIG. 14 is a schematic diagram showing the relation of the ADIP signals and frames of the conventional MD system and the next generation MD1 system;

FIG. 15 is a schematic diagram showing the relation between the ADIP signal and frames of the next generation MD1 system;

FIG. 16 is a schematic diagram describing a control signal of the next generation MD2 system;

FIG. 17 is a block diagram showing a disc drive device;

FIG. 18 is a block diagram showing the structure of a medium driving portion;

FIG. 19 is a flow chart showing an example of an initializing process for the disc of the next generation MD1;

FIG. 20 is a flow chart showing an example of an initializing process for the disc of the next generation MD2;

FIG. 21 is a schematic diagram describing a first example of an audio data managing system;

FIG. 22 is a schematic diagram describing an audio data file according to the first example of the audio data managing system;

FIG. 23 is a schematic diagram describing a track index file according to the first example of the audio data managing system;

FIG. 24 is a schematic diagram describing a play order table according to the first example of the audio data managing system;

FIG. 25 is a schematic diagram describing a programmed play order table according to the first example of the audio data managing system;

FIG. 26A and FIG. 26B are schematic diagrams describing a group information table according to the first example of the audio data managing system;

FIG. 27A and FIG. 27B are schematic diagrams describing a track information table according to the first example of the audio data managing system;

FIG. 28A and FIG. 28B are schematic diagrams describing a part information table according to the first example of the audio data managing system;

FIG. 29A and FIG. 29B are schematic diagrams describing a name table according to the first embodiment of the audio data managing system;

FIG. 30 is a schematic diagram describing an example of a process according to the first example of the audio data managing system;

FIG. 31 is a schematic diagram describing that a slot of the name table can be referenced from a plurality of pointers;

FIG. 32A and FIG. 32B are schematic diagrams describing a process for deleting a part from an audio data file according to the first example of the audio data managing system;

FIG. 33 is a schematic diagram describing a second example of the audio data managing system;

FIG. 34 is a schematic diagram showing the structure of an audio data file according to the second example of the audio data managing system;

FIG. 35 is a schematic diagram describing a track index file according to the second example of the audio data managing system;

FIG. 36 is a schematic diagram describing a play order table according to the second example of the audio data managing system;

FIG. 37 is a schematic diagram describing a programmed play order table according to the second example of the present invention;

FIG. 38A and FIG. 38B are schematic diagrams describing a group information table according to the second example of the audio data managing system;

FIG. 39A and FIG. 39B are schematic diagrams describing a track information table according to the second example of the audio data managing system;

FIG. 40A and FIG. 40B are schematic diagrams describing a name table according to the second example of the audio data managing system;

FIG. 41 is a schematic diagram describing an example of a process according to the second example of the audio data managing system;

FIG. 42 is a schematic diagram describing that data of one file is divided into a plurality of indexed areas with an index according to the second example of the audio data managing system;

FIG. 43 is a schematic diagram describing a connection of tracks according to the second example of the audio data managing system;

FIG. 44 is a schematic diagram describing a connection of tracks using another method according to the second example of the audio data managing system;

FIG. 45A and FIG. 45B are schematic diagrams describing that management right is transferred in accordance with the type of data to be written in the state that a personal computer and a disc drive device are connected;

FIG. 46A, FIG. 46B, and FIG. 46C are schematic diagrams describing a process for checking out a sequence of audio data;

FIG. 47 is a schematic diagram showing an example of the structure of a content distributing system according to an embodiment of the present invention;

FIG. 48 is a schematic diagram showing an example of a management table;

FIG. 49 is a schematic diagram showing an example of a buddy table;

FIG. 50 is a schematic diagram showing an example of software according to an embodiment of the present invention;

FIG. 51 is a schematic diagram showing an example of the structure of an information provider side and an information recipient side of a content distributing system according to the embodiment of the present invention; and

FIG. 52 is a schematic diagram showing a flow of an example of a process of the content distributing system according to the embodiment of the present invention.

### DETAILED DESCRIPTION OF THE PREFERRED EMBODIMENTS

Next, an embodiment of the present invention will be described. Before description of the embodiment of the present invention, a disc system according to the present invention will be described in the order of the following nine sections.
1. Outline of recording system
2. About disc
3. Signal format
4. Structure of recording and reproducing apparatus
5. Initializing processes for discs of next generation MD1 system and next generation MD2 system
6. First managing system for music data
7. Second example of managing system for music data
8. Operation when connected to personal computer
9. Copy restriction of audio data recorded on disc
   1. Outline of Recording System

According to an embodiment of the present invention, a magneto-optical disc is used as a recording medium. A physical attribute such as a form factor of the magneto-optical disc is substantially the same as that of a disc used for the so-called MD system. However, data recorded on the disc and locations of data on the disc according to the embodiment are different from those of the conventional MD.

In reality, an apparatus according to the embodiment records and reproduces content data such as audio data in accordance with the file allocation table (FAT) system as a file managing system. Thus, it is assured that the apparatus has compatibility with a conventional personal computer.

In this example, terms “FAT” or “FAT system” are used to generally represent various types of PC based file systems. Thus, they do not represent only a predetermined FAT based file system used in DOS (Disk Operating System), VFAT (virtual FAT) used in Windows (registered trademark of Microsoft Corp.) 95/98, FAT32 and NTFS (NT file system (also referred to as new technology file system)) used in Windows 98/ME/2000. The NTFS is a file system used in the Windows NT operating system or (optionally) Windows 2000 operating system. In the NTFS, while data is read from a disc or written thereto, a file is retrieved or recorded, respectively.

In addition, according to the embodiment of the present invention, the error correcting system and the modulating system of the conventional MD system are improved so as to increase the recording capacity for data. Moreover, according to the embodiment of the present invention, content data is encrypted and copy is prevented from being illegally copied so as to protect copyright of content data.

As recording and reproducing formats, there are specifications of a next generation MD1 system and specifications of a next generation MD2 system. The next generation MD1 system uses a disc (namely, a physical medium) that is the same as the conventional MD system. The next generation MD2 system uses a disc having the same form factor and outer shape as the disc of the conventional MD system and having an increased recording density in linear recording direction and an increased recording capacity obtained by the magnetically induced super resolution (MSR) technology. These specifications have been developed by the inventor of the present invention.

In the conventional MD system, a cartridge type magneto-optical disc having a diameter of 64 mm is used as a recording medium. The disc has a thickness of 1.2 mm. The disc has a center hole having a diameter of 11 mm. The cartridge is 68 mm long, 72 mm wide, and 5 mm thick.

The shapes of the disc and cartridge of the disc of each of the next generation MD1 system and the next generation MD2 system are the same as those of the disc of the conventional MD system. The lead-in area of the disc of each of the next generation MD1 system and the next generation MD2 system starts from 29 mm, which is the same as the disc of the conventional MD system.

It is considered that the track pitch of the next generation MD2 is 1.2 μm to 1.3 μm (for example, 1.25 μm). In contrast, the track pitch of the next generation MD1 system that follows the specifications of the conventional MD system is 1.6 μm. The pit length of the next generation MD1 system is 0.44 μm/bit. The pit length of the next generation MD2 system is 0.16 μm/bit. The redundancy of each of the next generation MD1 system and the next generation MD2 system is 20.50%.

In the disc of the next generation MD2 system, the recording capacity in the linear density direction is increased using the magnetically induced super resolution technology. The magnetically induced super resolution technology uses the theory of which when a cutting layer is heated at a predetermined temperature, the cutting layer becomes a magnetically neutral state, a magnetic domain wall that has been transferred to a reproduction layer is moved, and then a small mark looks like a large mark in a beam spot.

In other words, the disc of the next generation MD2 system is composed of a transparent substrate, a first magnetic layer as an information recording layer, a cutting layer as an exchange coupling force adjusting layer, and a second magnetic layer as information reproducing layer that are successively formed. When data is recorded, a small mark can be generated using a laser pulse magnetic field modulation technology.

In the disc of the next generation MD2 system, the depth and inclination of grooves is larger than those of the disc of the conventional MD system so as to improve a de-track margin and suppress cross-talk from a land, a cross-talk of a wobble signal, and focus error. In the disc of the next generation MD2 system, the depth of grooves is for example in the range from 160 nm to 180 nm, the inclination of grooves is for example in the range from 60 degrees to 70 degrees, and the width of grooves is for example in the range from 600 nm to 700 nm.

According to optical specifications of the next generation MD1 system, the laser wavelength λ is 780 nm and the numerical aperture NA of an objective lens of an optical head is 0.45. Likewise, according to optical specifications of the next generation MD2 system, the laser wavelength λ is 780 nm and the numerical aperture NA of an optical head is 0.45.

The next generation MD1 system and the next generation MD2 system use as a recording system a groove recording system. In other words, data is recorded and reproduced to and from grooves (formed on a disc surface) as tracks.

The conventional MD system uses a convolution code that uses advanced cross interleave Reed-Solomon code (ACIRC) as an error correction code encoding system. On the other hand, the next generation MD1 system and the next generation MD2 system use a block completion type code that is a combination of Reed-Solomon long distance code (RS-LDC) and burst indicator subcode (BIS). Since the block completion type error correction code is used, a linking sector can be omitted. In the error correcting system that is a combination of the LDC and the BIS, when a burst error takes place, an error location can be detected with the BIS. In accordance with the error location, erasure correction can be performed with the LDC.

As an address system, a wobbled groove system is used. In the wobbled groove system, grooves are formed in a single spiral shape. The grooves are wobbled as address information on both sides of the grooves. Such an address system is referred to as address in pregroove (ADIP). The conventional MD system, the next generation MD1 system, and the next generation MD2 system differ in their liner densities. The conventional MD system uses a convolution code referred to as ACIRC as an error correction code, whereas the next generation MD1 system and the next generation MD2 system use a block completion type code that is a combination of the LDC and the BIS. Thus, the redundancy of the conventional MD system is different from that of the next generation MD1 system and the next generation MD2 system. Thus, the relative positions of the ADIP and data of the conventional MD system are different from those of the next generation MD1 system and the next generation MD2 system. Consequently, the next generation MD1 system that follows the physical structure of the disc of the conventional MD system treats an ADIP signal in a different manner from the conventional MD system. Thus, the ADIP signal is changed in the next generation MD2.

As a modulating system, the conventional MD system uses the 8 to 14 modulating (EFM) method. In contrast, the next generation MD1 system and the next generation MD2 system use RLL (1, 7) PP (PLL: Run Length Limited, PP: Parity Preserve/Prohibit RMTR (repeated minimum transition run length)) (hereinafter referred to as 1-7 pp modulation). As a data detecting system, the next generation MD1 system uses partial response PR(1, 2, 1) ML. The next generation MD2 system uses Viterbi decoding system that uses partial response PR(1, −1) ML.

As a disc driving system, the standard liner velocity as constant linear velocity (CLV) or zone constant angular velocity (ZCAV) of the next generation MD1 system is 2.4 m/second. The linear velocity as CLV or ZCAV of the next generation MD2 system is 1.98 m/second. The linear velocity as CLV or ZCAV of a 60-minute disc of the conventional MD system is 1.2 m/second. The linear velocity as CLV or ZCAV of a 74-minute disc of the conventional MD system is 1.4 m/second.

The total data recording capacity of a 80-minute disc of the next generation MD1 system that follows the specifications of the disc of the conventional MD system is approximately 300 Mbytes. Since the next generation MD1 system uses as a modulating system the 1-7 pp modulating system instead of the EFM system, the window margin is in the range from 0.5 to 0.666. Thus, the next generation MD1 system has a high recording density that is 1.33 times higher than the conventional MD system. As an error correcting system, the next generation MD1 system uses the combination of the BIS and the LDC instead of the ACIRC system. Thus, the data efficiency of the next generation MD1 system is improved. As a result, in the next generation MD1 system, a high recording density that is 1.48 times higher than the conventional MD system can be accomplished. Generally, when the same disc is used, the next generation MD1 system accomplishes a data capacity two times higher than the conventional MD system.

Since the disc of the next generation MD2 system that uses the magnetically induced super resolution also has a high density in the linear density direction, the total data recording capacity thereof is as high as around 1 GB.

The data rate as the standard linear velocity of the next generation MD1 system is 4.4 Mbits/second, whereas the data rate as the standard linear velocity of the next generation MD2 system is 9.8 Mbits/second.

2. About disc

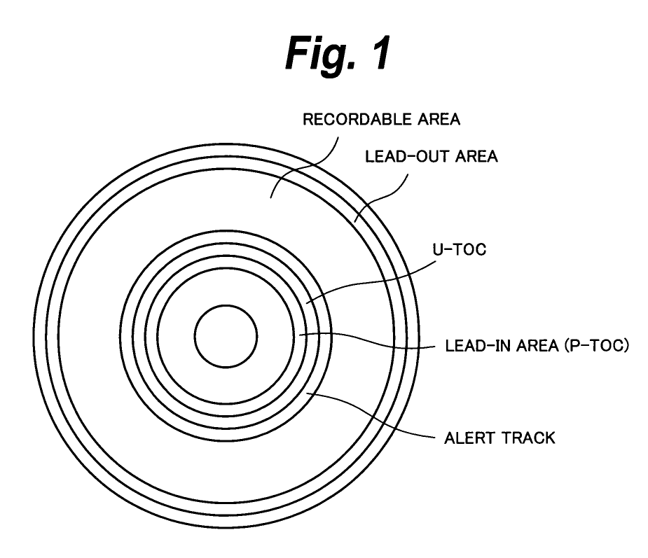

FIG. 1 shows the structure of the disc of the next generation MD1 system. The disc of the next generation MD1 system follows the specifications of the disc of the conventional MD system. In other words, the disc of the next generation MD1 system is composed of a transparent polycarbonate substrate, a first dielectric film, a magnetic film, a second dielectric film, and a reflection film that are successively formed. In addition, above the reflection film, a protection film is formed.

As shown in FIG. 1, a pre-mastered table of contents (P-TOC) area is formed in a lead-in area on the innermost periphery of the disc (“innermost periphery” represents the innermost peripheral position in the radial direction from the center of the disc). As a physical structure, the P-TOC area is a pre-mastered area. In other words, control information and so forth are recorded as for example P-TOC information of embossed pits.

An outer periphery of the lead-in area of the P-TPC area (an outer periphery in the radial direction from the center of the disc) is a recordable area (an area in which data can be opto-magnetically recorded). On the outer periphery, a recordable and reproducible area is formed with guide grooves as recording tracks. A user table of contents (U-TOC) is formed on an inner periphery of the recordable area.

The structure of the U-TOC of the disc of the next generation MD1 system is the same as that of the disc of the conventional MD system. The U-TOC is management information that is rewritten in accordance with the order of tracks (audio tracks/data tracks) and they are recorded or erased. The U-TOC serves to manage the start position, end position, and mode of each track (a part that composes a track).

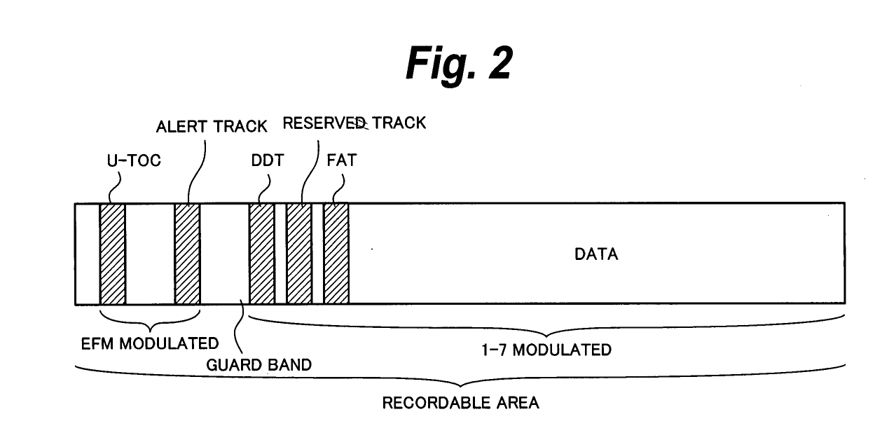

On an outer periphery of the U-TOC, an alert track is formed. On the alert track, an alarm sound is recorded. When the disc of the next generation MD1 system is loaded into a conventional MD system, the alarm sound is activated (output) by the MD player. The alarm sound informs the user that the disc can be used in the next generation MD1 system, not reproduced by the conventional system. The remaining portion of the recordable area (for detail, see FIG. 2) extends to the lead-out area in the radial direction.

FIG. 2 shows the structure of the recordable area of the disc of the next generation MD1 system shown in FIG. 1. As shown in FIG. 2, at the beginning of the recordable area (inner periphery side), the U-TOC and the alert track are formed. Data modulated in accordance with the EFM system is recorded in the area that contains the U-TOC and the alert track so that the data can be reproduced by a player of the conventional MD system. On an outer periphery of the area in which EFM modulated data is recorded, an area in which 1-7 pp modulated data of the next generation MD1 system is formed. A “guard band” for a predetermined length is formed between the area in which the EFM modulated data is recorded and the area in which the 1-7 pp modulated data is recorded. Even if the disc of the next generation MD1 system is loaded into a player of the conventional MD system, the guard band prevents a trouble from taking place.

At the beginning of the area in which the 1-7 pp modulated data is recorded (on an inner periphery side), a disc description table (DDT) area and a reserved track are formed. The DDT area serves to perform a substituting process for a physically defect area. In the DDT area, an identification code that is unique to each disc is recorded. Hereinafter, an identification code unique to each disc is referred to as unique ID (UID). In the next generation MD1 system, the UID is generated in accordance with a random number that is generated in a predetermined manner. The UID is recorded when the disc is initialized (as will be described later). With the UID, a security management for contents of the disc can be performed. The reserved track contains information for protecting a content.

In the area in which the 1-7 pp modulated data is recorded, a file allocation table (FAT) area is formed. The area for the FAT serves to manage data in accordance with the FAT system. The FAT system of the next generation MD1 system serves to manage data in accordance with the FAT system of the general-purpose personal computer. The FAT system manages files with a file at the root, a directory that represents an entry point of a directory, and a FAT table describing connection information of a FAT cluster. As described above, the term FAT is generally used for various file managing methods used in PC operating systems.

The U-TOC area of the disc of the next generation MD1 system contains information of the start position of the alert track and information of the start position of the area in which the 1-7 pp modulated data is recorded.

When the disc of the next generation MD1 system is loaded into a player of the conventional MD system, the U-TOC area is read. The position of the alert track is obtained from the information of the U-TOC. As a result, the alert track is accessed and reproduced. An alarm sound that informs the user that the disc is used for the next generation MD1 system, not a player of the conventional MD system is recorded. With the alarm sound, the user knows that the disc cannot be used on a player of the conventional MD system.

As an alarm sound, a verbal alarm like “This player cannot be used!” may be generated. Of course, the alarm sound may be a simple beep sound, a tone, or another alarm signal.

When the disc of the next generation MD1 system is loaded into a player of the next generation MD1 system, the U-TOC area is read from the disc. The start position of the area in which the 1-7 pp modulated data is recorded is obtained from the information of the U-TOC. Thereafter, the DDT, the reserved track, and the area for the FAT are read. In the area in which the 1-7 pp modulated data is recorded, data is managed in accordance with the FAT system rather than the U-TOC.

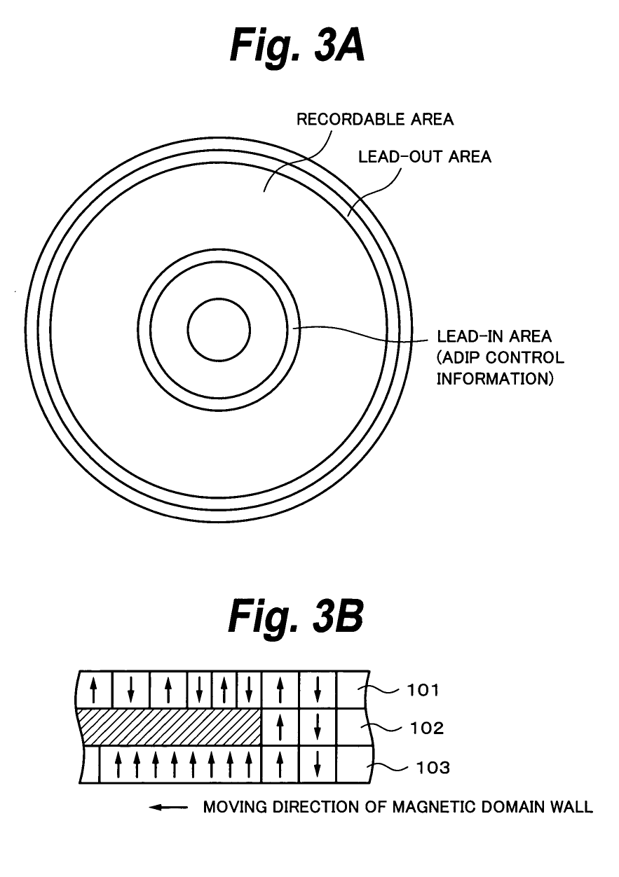

FIG. 3A and FIG. 3B show the disc of the next generation MD2 system. The disc is composed of a transparent polycarbonate substrate, a first dielectric film, a magnetic film, a second dielectric film, and a reflection film that are successively formed. Above the reflection film, a protection layer is formed.

As shown in FIG. 3A, on the disc of the next generation MD2 system, control information of an ADIP signal is recorded in a lead-in area on an inner periphery (an inner periphery in the radial direction from the center of the disc). On the disc of the next generation MD2 system, a P-TOC of embossed pits is not formed in the lead-in area. Instead, the control information of the ADIP signal is used. A recordable area starts from an outer periphery of the lead-in area. The recordable area is a recordable and reproducible area in which guide grooves are formed as recording tracks. In the recordable area, 1-7 pp modulated data is recorded.

As shown in FIG. 3B, the disc of the next generation MD2 system is composed of a magnetic layer 101 as a recording layer in which information is recorded as a magnetic film, a cutting layer 102, and a magnetic layer 103 from which information is reproduced that are successively formed. The cutting layer 102 is an exchange coupling force adjusting layer. When the temperature of the cutting layer 102 becomes a predetermined temperature, it becomes a magnetically neutral state. A magnetic wall transferred to the magnetic layer 101 is transferred to the magnetic layer 103. Thus, a small mark on the magnetic layer 101 looks like a large mark in a beam spot of the magnetic layer 103.

On the disc of the next generation MD2 system, the foregoing UID is pre-recorded in an area on the inner periphery side (the area is not shown) from which data can be reproduced by a consumer type recording and reproducing apparatus and to which data cannot be recorded thereby. On the disc of the next generation MD2 system, the UID is pre-recorded on the disc by a technology similar to the technology of the burst cutting area (BCA) used in for example a digital versatile disc (DVD). Since the UID is generated and recorded on the disc when it is produced, the UID can be managed. Thus, the security of the disc of the next generation MD2 system is higher than that of the next generation MD1 system of which the UID is generated with a random number when the disc is initialized. The format of the UID will be described later.

For simplicity, the area in which the UID is pre-recorded in the next generation MD2 system is referred to as BCA.

It is determined whether or not the loaded disc is the disc of the next generation MD1 system or the disc of the next generation MD2 system in accordance with for example the information of the lead-in area of the loaded disc. In other words, when the P-TOC of embossed pits is detected from the lead-in area, it is determined that the loaded disc is the disc of the conventional MD system or the disc of the next generation MD1 system. In contrast, when the control information of the ADIP signal is detected from the lead-in area and the P-TOC of embossed pits is not detected from the lead-in area, it is determined that the loaded disc is the disc of the next generation MD2 system. Alternatively, the determination may be performed in accordance with the UID contained in the BCA. The determination of whether the loaded disc is the disc of the next generation MD1 system or the disc of the next generation MD2 system is not limited to such a method. In other words, the determination may be performed in accordance with the phase of the tracking error signal in on track state and off track state. Of course, a detection hole for determining the disc type may be formed.

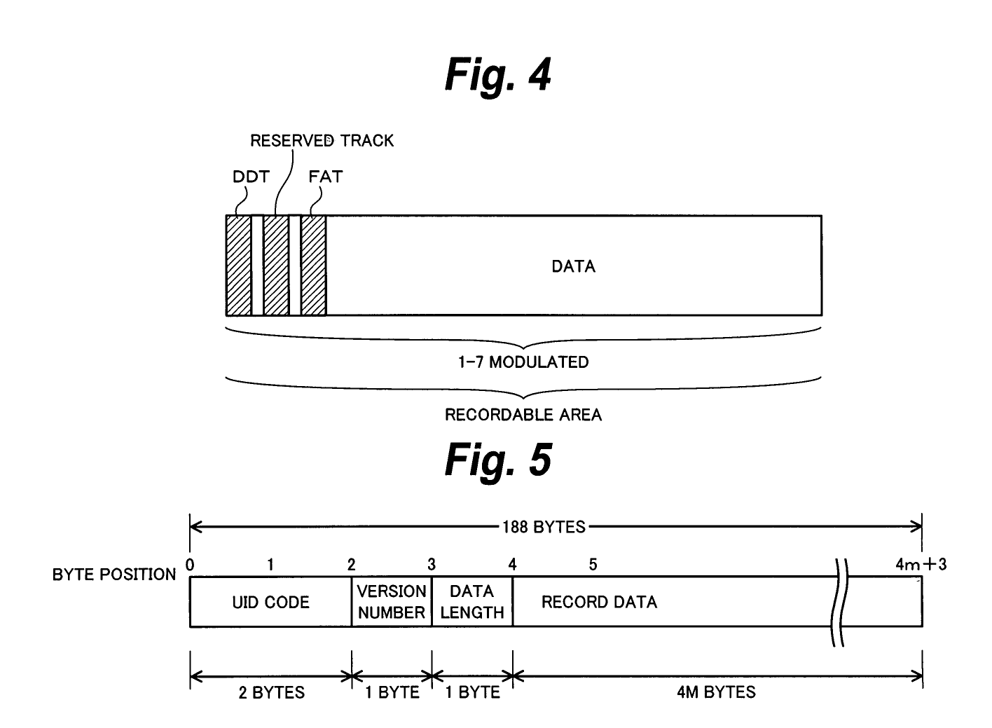

FIG. 4 shows the structure of the recordable area of the disc of the next generation MD2 system. As shown in FIG. 4, data recorded in the recordable area is only 1-7 pp modulated data. At the beginning of the area in which the 1-7 pp modulated data is recorded (on the inner periphery side), a DDT area and a reserved track are formed. The DDT area serves to record substitute area management data with which a substitute area for a physically defective area is managed.

In reality, the DDT area has a management table that manages a substitute area including a recordable area substituted for a physically defective area. The management table describes a logical cluster determined as a defective logical cluster. The management table also describes at least one logical cluster in the substitute area allocated as a substitute cluster for a defective cluster. In addition, the DDT area describes the foregoing UID. The reserved track describes information for protecting a content.

In the area in which the 1-7 pp modulated data is recorded, an area for the FAT is also formed. The area for the FAT is an area in which data is managed in accordance with the FAT system. The FAT system manages data in accordance with the FAT system used in the general-purpose computer.

The disc of the next generation MD2 system does not have the U-TOC area. When the disc of the next generation MD2 system is loaded into a player of the next generation MD2 system, the DDT, the reserved track, and the area for the FAT are read from the predetermined positions of the disc. Data is managed in accordance with the FAT system.

It is known that the disc of the next generation MD1 system and the disc of the next generation MD2 system do not need to perform initializing operation that requires a time. In other words, the disc of the next generation MD1 system and the disc of the next generation MD2 system do not need the initializing process, but the DDT, the reserved track, and the FAT table as a minimally required table. Data can be directly recorded to the recordable area of an unused disc or reproduced therefrom.

As described above, when the disc of the next generation MD2 system is produced, since the UID is generated and recorded thereon, security of data recorded thereon can be strongly managed. However, since the number of layers of the disc of the next generation MD2 system is larger than that of the disc of the conventional MD system, the former is more expensive than the latter. Thus, a disc system whose disc recordable area, lead-in area, and lead-out area are in common with the disc of the next generation MD1 system and whose UID is the same as the disc of the next generation MD2 system has been proposed. This disc system is referred to as next generation MD 1.5 system.

Unless necessary, description of the next generation MD 1.5 system will be omitted. In other words, it is supposed that the UID of the next generation MD 1.5 system is based on that of the next generation MD2 system and that recording and reproducing operations for audio data of the next generation MD 1.5 system are based on those of the next generation MD1 system.

Next, the UID will be described in more detail. As described above, when the disc of the next generation MD2 system is produced, the UID is recorded thereon using a technology similar to the BCA for a DVD. FIG. 5 shows an example of the format of the UID. The entire UID is referred to as UID record block.

In the UID block, the first two bytes are a field for a UID code. The high order four bits of the two bytes, namely 16 bits, of the UID code are used to determine the disc. When the four bits are [0000], it represents that the loaded disc is the disc of the next generation MD2 system. When the four bits are [0001], it represents that the loaded disc is the disc of the next generation MD 1.5 system. Other values of the four bits are reserved for future use. The low order 12 bits of the two bytes are an application ID that represent 4096 types of services.

The UID code is followed by a one-byte field for a version number. The version number field is followed by a one-byte field for a data length. The data length field represents the data length of a field for UID record data preceded by the data length field. The UID record data field has a data length of 4 m bytes (where m=0, 1, 2, . . . ) under the condition that the data length of the entire UID does not exceed 188 bytes. A unique ID generated by a predetermined method can be recorded in the UID record data field. Thus, the disc can be identified.

In the disc of the next generation MD1 system, an ID generated with a random number is recorded in the UID record data field.

A plurality of UID record blocks each of which has a data length of up to 188 bytes can be formed.

3. Signal format Next, signal formats of the next generation MD1 system and the next generation MD2 system will be described. The conventional MD system uses as an error correction system the ACIRC that is a convolution code. A sector composed of 2352 bytes corresponding to the data amount of a sub code block is used as an access unit for which data is recorded or reproduced at a time. When a convolution code is used, an error correction code sequence occupies a plurality of sectors. Thus, when data is rewritten, it is necessary to place a linking sector between adjacent sectors. The next generation MD1 system and the next generation MD2 system use as an address system, the ADIP that is a wobbled groove system of which grooves are formed in a single spiral shape and the grooves are wobbled on both sides thereof as address information. In contrast, the conventional MD system uses the ADIP signal so that sectors each of which is composed of 2352 bytes can be optimally accessed.

In contrast, the next generation MD1 system and the next generation MD2 system use a block completion type code that is a combination of the LDC and the BIS. 64 Kbytes are used as an access unit for which data is recorded or reproduced at a time. The block completion type code does not need a linking sector. Thus, the next generation MD1 system that follows the specifications of the disc of the conventional MD system changes the ADIP signal in accordance therewith. Likewise, the next generation MD2 system changes the ADIP signal in accordance therewith.

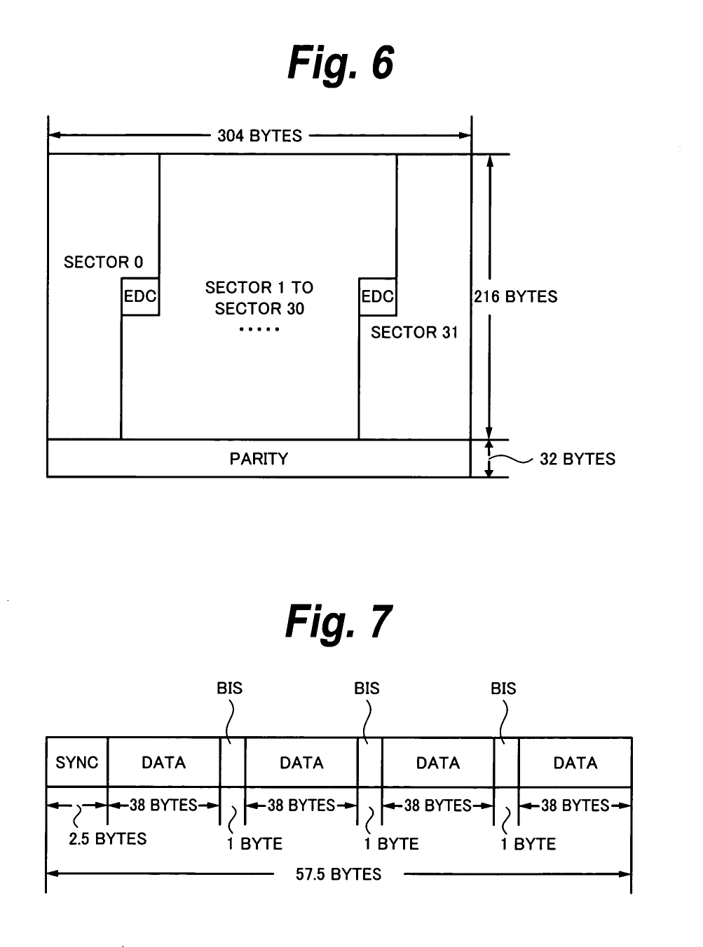

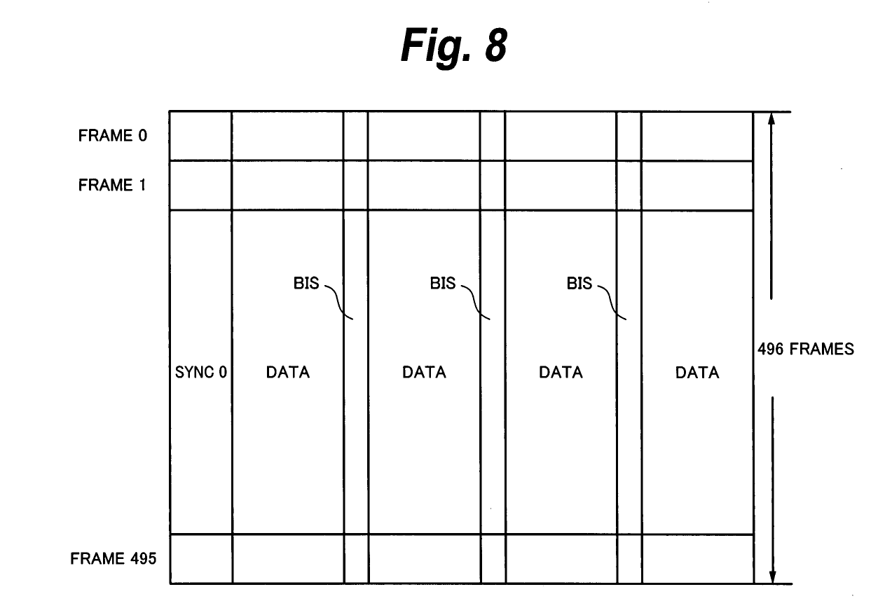

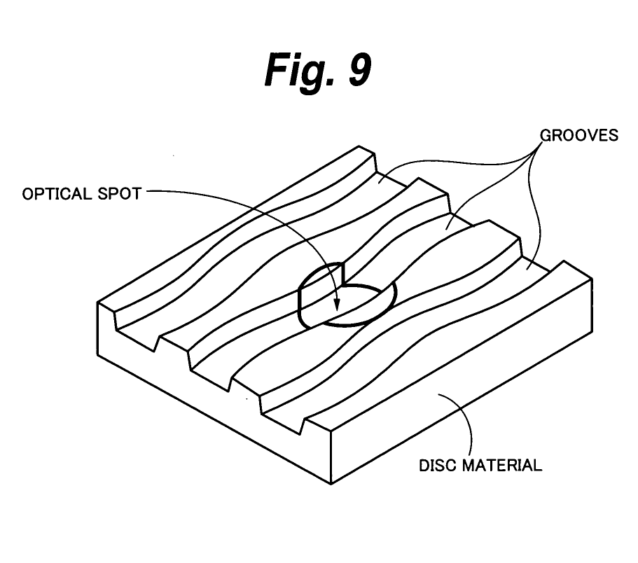

FIG. 6, FIG. 7, and FIG. 8 describe the error correcting systems used for the next generation MD1 system and the next generation MD2 system. The next generation MD1 system and the next generation MD2 system use the combination of an error correction code encoding system of an LDC shown in FIG. 6 and a BIS system shown in FIG. 7 and FIG. 8.

FIG. 6 shows the structure of a code block encoded with an error correction code using the LDC. As shown in FIG. 6, an error detection code EDC of four bytes is added to data of each sector of the code block. Data is two-dimensionally arranged as the code block of 304 bytes in the horizontal direction x 216 bytes in the vertical direction. Each sector of the code block is composed of 2 Kbytes. As shown in FIG. 6, 32 sectors are placed. An error correction Reed-Solomon code parity having a length of 32 bits is placed along the sectors of the code block.

FIG. 7 and FIG. 8 show the structure of the BIS. As shown in FIG. 7, the BIS of one byte is placed at an interval of 38 bytes. A total of 157.5 bytes of data (38×4=152 bytes), BIS data of 3 bytes, and a frame sync of 2.5 bytes composes one frame.

As shown in FIG. 8, one block of the BIS is composed of 496 frames. Data of the BIS (3×496=1488 bytes) contains user control data of 576 bytes, an address unit number of 144 bytes, and an error correction code of 768 bytes.

In the data of the BIS, an error correction code of 768 bytes is added to data of 1488 bytes. Thus, an error can be strongly corrected. When a code of the BIS is placed at an interval of 38 bytes, if a burst error occurs, the location of the error can be detected. With the error location, an erasure correction using the LDC code can be performed.

The ADIP signal is recorded with wobbled grooves on both the sides thereof in the single spiral shape. In other words, the ADIP signal has FM modulated address data and is recorded as wobbled grooves of a disc material.

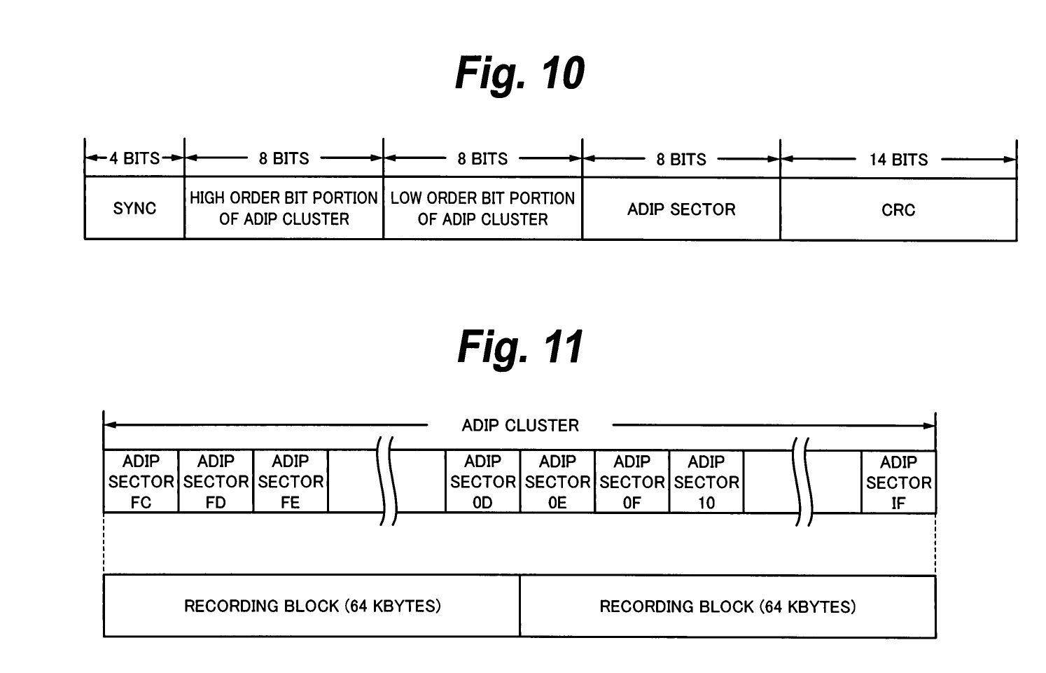

FIG. 10 shows the format of a sector of the ADIP signal of the next generation MD1 system.

As shown in FIG. 10, one sector of the ADIP signal (ADIP sector) is composed of a sync of four bits, a high order bit portion of an ADIP cluster number of eight bits, a low order bit portion of the ADIP cluster number of eight bits, an ADIP sector number of eight bits, and an error detection code CRC of 14 bits.

The sync is a signal having a predetermined pattern with which the beginning of the ADIP sector is detected. Since the conventional MD system uses a convolution code, it needs a linking sector. A sector number of a linking sector has a negative value such as “FCh”, “FDh”, “FEh”, and ‘FFh” (where h represents hexadecimal notation). Since the next generation MD1 system follows the specifications of the conventional MD system, the format of the ADIP sector of the next generation MD1 system is the same as that of the conventional MD system.

As shown in FIG. 11, in the next generation MD1 system, an ADIP cluster is composed of 36 sectors of ADIP cluster numbers “FCh” to “FFh” and “0Fh” to “1Fh”. As shown in FIG. 10, data of two recording blocks (64 Kbytes) is placed in one ADIP cluster.

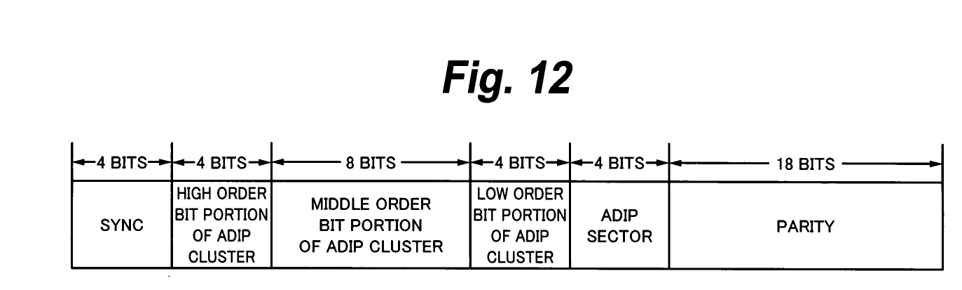

FIG. 12 shows the structure of an ADIP sector of the next generation MD2 system. In the next generation MD2 system, an ADIP sector is composed of 16 sectors. Thus, an ADIP sector number can be represented by four bits. In addition, the next generation MD systems use the block completion type code, they do not need to use a linking sector.

As shown in FIG. 12, an ADIP sector of the next generation MD2 system is composed of a sync of four bits, a high order bit portion of an ADIP cluster number of four bits, a middle order bit portion of the ADIP cluster number of eight bits, and a low order bit portion of the ADIP cluster number of four bits, and an error correction parity of 18 bits.

The sync is a signal having a predetermined pattern with which the beginning of the ADIP sector is detected. The ADIP cluster number is composed of a total of 16 bits of the high order portion of four bits, the middle order portion of eight bits, and the low order portion of four bits. 16 ADIP sectors compose an ADIP cluster. Thus, a sector number of an ADIP sector is composed of four bits. Although the conventional MD system uses an error detection code of 14 bits, it uses an error correction parity of 18 bits. In the next generation MD2 system, data of one recording block (64 Kbytes) is placed in one ADIP cluster.

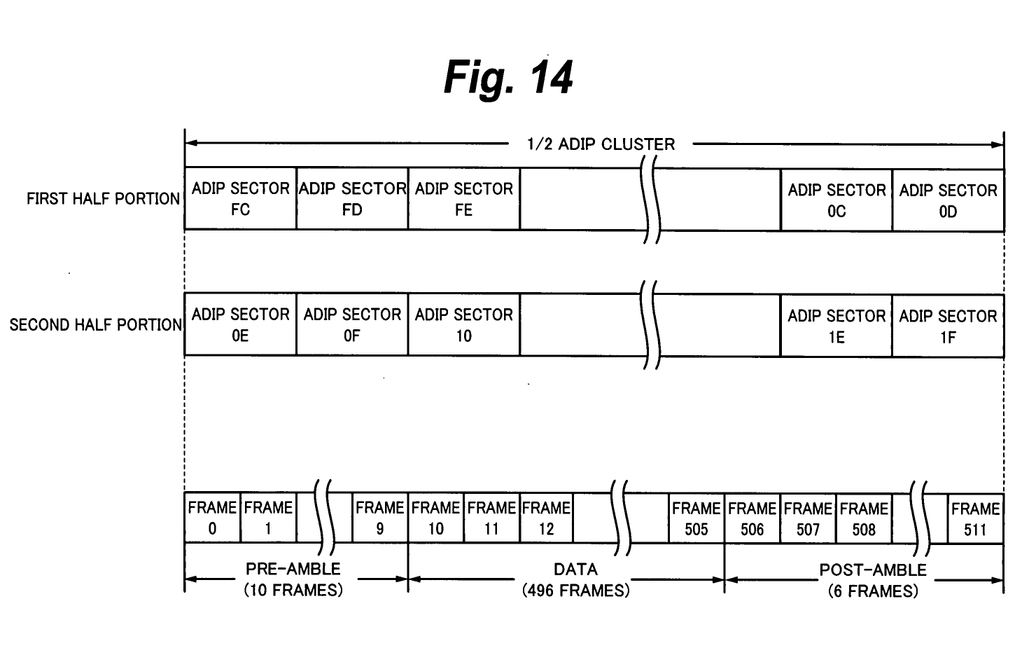

FIG. 14 shows the relation of an ADIP cluster and BIS frames of the next generation MD1 system.

As shown in FIG. 11, in the next generation MD1 system, one ADIP cluster is composed of 36 sectors of ADIP sectors “FC” to “FF” and ADIP sectors “00” to “1F”. Two sets of data of one recording block (64 Kbytes) as a unit for which data is recorded or reproduced at a time are placed in one ADIP cluster.

As shown in FIG. 14, one ADIP sector is divided into a first half portion of 18 sectors and a second half portion of 18 sectors.

Data of one recording block as a unit for which data is recorded or reproduced at a time is placed in one BIS block composed of 496 frames. Before 496 frames equivalent to a BIS block (from frame “10” to frame “505”), a pre-amble of 10 frames (frame “0” to frame “9”) are added. After the data of the frames, a post-amble of six frames (from frame “506” to frame “511”) is added. Data of a total of 512 frames is placed in a first half portion of the ADIP cluster from ADIP sector “FCh” to ADIP sector “0Dh”. In addition, data of a total of 512 frames is placed in a second half portion of the ADIP cluster from ADIP sector “0Eh” to ADIP sector “1Fh”. The frames of the pre-amble of the data frames and the frames of the post-amble of the data frames are used to protect data of adjacent recording blocks that are linked. The pre-amble is also used to activate PLL for data, control an amplitude of a signal, and control a signal offset.

A physical address to or from which data of a recording block is recorded or reproduced is designated in accordance with a ADIP cluster and the first half or the second half thereof. When data is recorded or reproduced with a physical address designated, an ADIP sector is read from the ADIP signal. An ADIP cluster number and an ADIP sector number are read from a reproduction signal of the ADIP sector so as to determine whether or not the ADIP cluster is the first half or the second half.

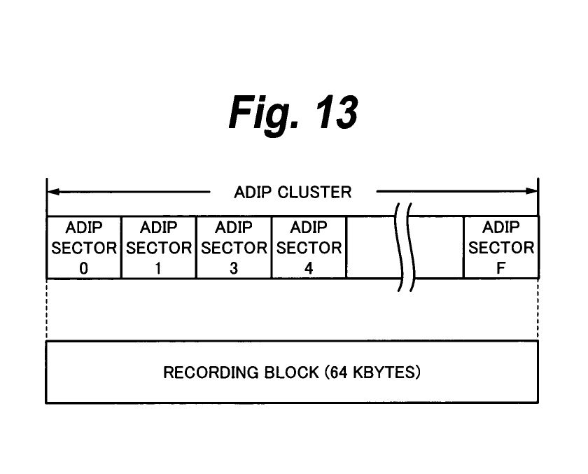

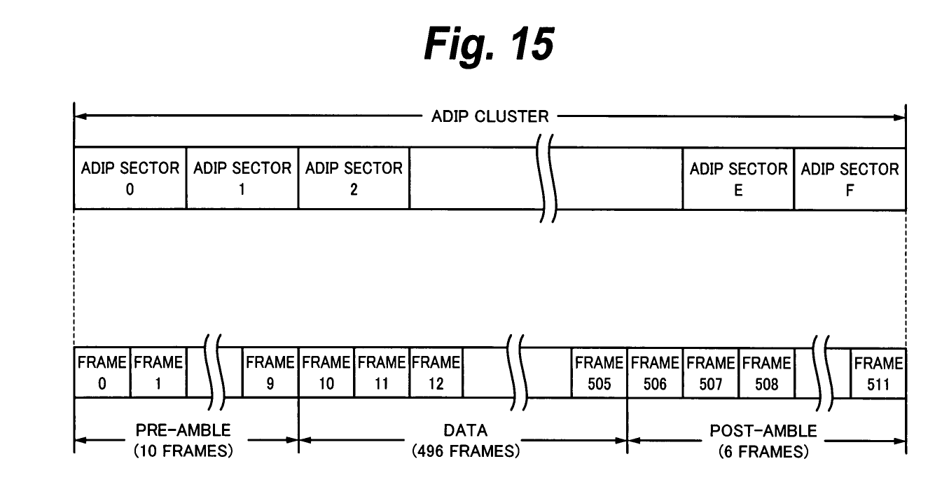

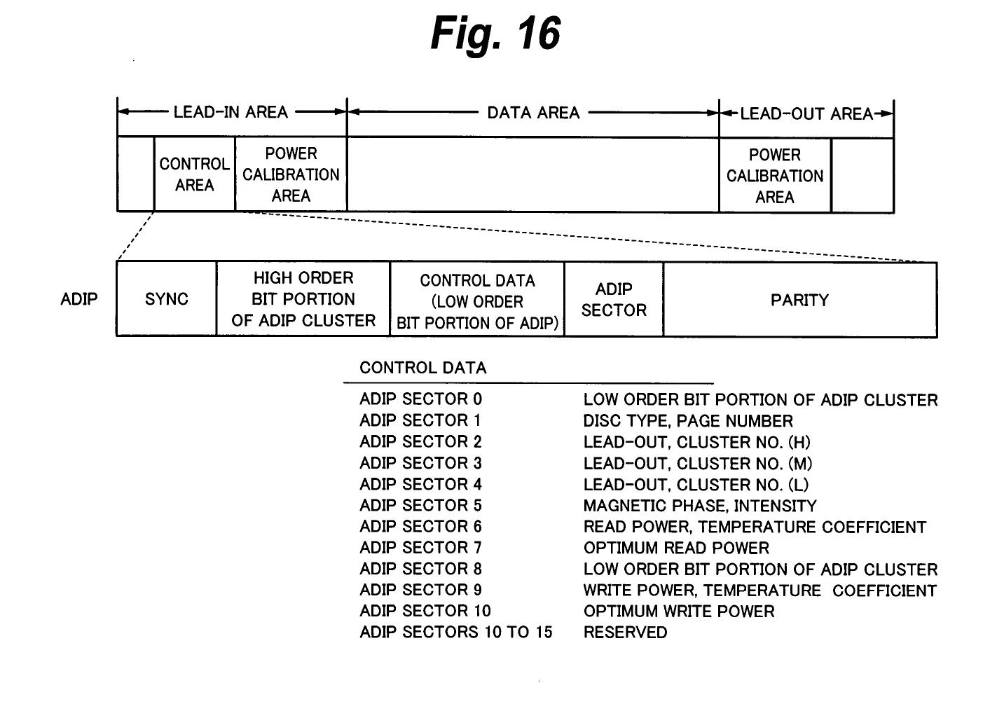

FIG. 15 shows the relation between a an ADIP cluster and BIS frames of the next generation MD2 system. As shown in FIG. 13, in the next generation MD2 system, one ADIP cluster is composed of 16 ADIP sectors. Data of one recording block (64 Kbytes) is placed in one ADIP cluster.

As shown in FIG. 15, data of one recording block (64 Kbytes) as a unit for which data is recorded or reproduced at a time is placed in a BIS block composed of 496 frames. Before 496 frames equivalent to a BIS block (from frame “10” to frame “505”), a pre-amble of 10 frames (frame “0” to frame “9”) are added. After the data of the frames, a post-amble of six frames (from frame “506” to frame “511”) is added. Data of a total of 512 frames is placed in a first half portion of the ADIP cluster from ADIP sector “FCh” to ADIP sector “0Dh”.

The frames of the pre-amble preceded by the data frames and the frames of the post-amble followed by the data frames are used to protect data when adjacent recording blocks are linked.

The frames of the pre-amble of the data frames and the frames of the post-amble of the data frames are used to protect data of adjacent recording blocks that are linked. The pre-amble is also used to activate PLL for data, control an amplitude of a signal, and control a signal offset.

When a recording operation or a reproducing operation is started for such a disc, various types of control information are required to control a laser power. On the disc of the next generation MD1 system, as shown in FIG. 1, the P-TOC is formed in the lead-in area. Various types of control information are obtained from the P-TOC.

On the disc of the next generation MD2 system, a P-TOC of embossed pits is formed. Instead, control information is recorded as an ADIP signal in the lead-in area of the disc. On the other hand, since the disc of the next generation MD2 system uses the technology of the magnetically induced super resolution, the power control of the laser is important. The disc of the next generation MD2 system has a calibration area for which the laser power is controlled in each of the lead-in area and the lead-out area.

FIG. 16 shows the structure of the lead-in area and the lead-out area of the disc of the next generation MD2 system. As shown in FIG. 16, in each of the lead-in area and the lead-out area, a power calibration area is formed as a laser beam power control area.

In addition, in the lead-area, a control area for control information using the ADIP is formed. When control information using the ADIP is recorded, control information of the disc is described with an area assigned as low order bits of an ADIP cluster number.

In other words, an ADIP cluster number starts from the start position of the recordable area. In the lead-in area, the ADIP cluster number is a negative value. As shown in FIG. 16, an ADIP sector of the disc of the next generation MD2 system is composed of a sync of four bits, a high order bit portion of an ADIP cluster number of eight bits, control data of eight bits (a low order bit portion of the ADIP cluster number), an ADIP sector number of four bits, and an error correction parity of 18 bits. As shown in FIG. 16, control information such as the disc type, magnetic phase, intensity, and read power is described with eight bits assigned as the low order bit portion of the ADIP cluster number.

Since the high order bits of the ADIP cluster are left, the current position can be obtained with a particular accuracy. When low order eight bits of the ADIP cluster number are left in ADIP sector “0” and ADIP sector “8”, the ADIP cluster can be accurately detected at a predetermined interval.

Details of a control signal recorded as an ADIP signal are described in the specification of Japanese Patent Application 2001-123535 that the applicant of the present patent application has proposed.

4. Structure of Recording and Reproducing Apparatus

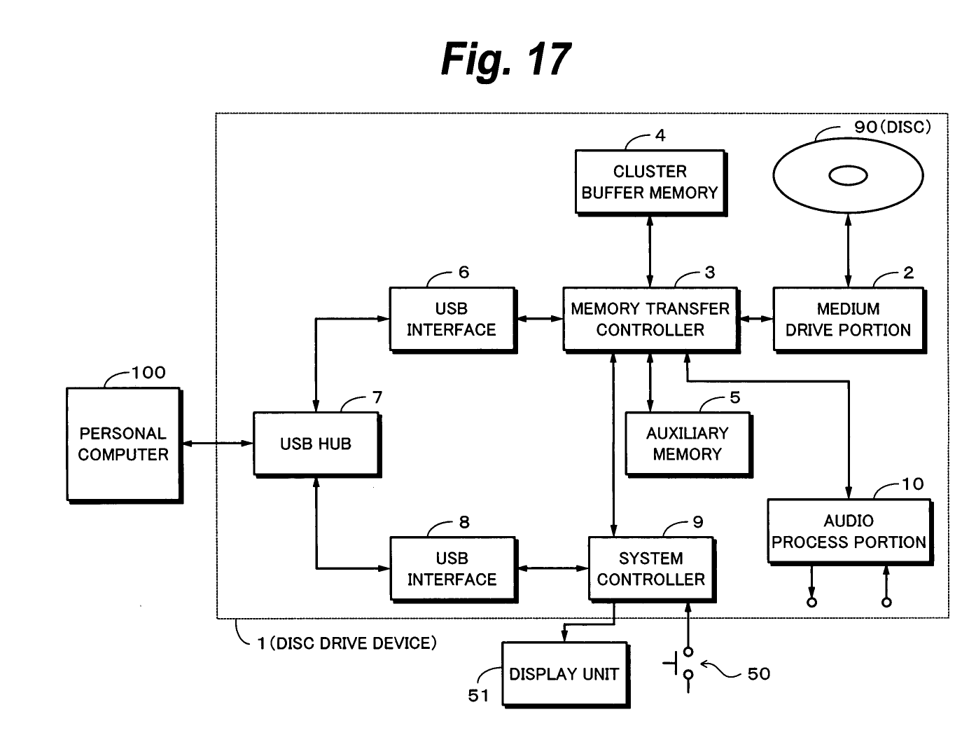

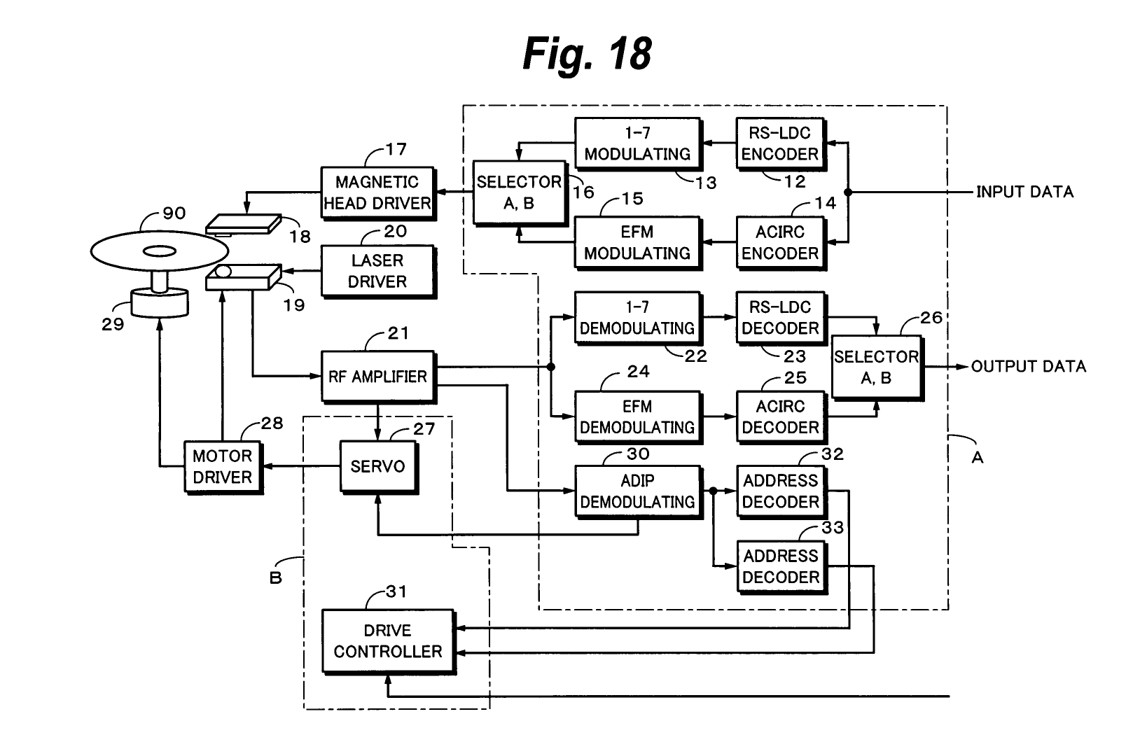

Next, with reference to FIG. 17 and FIG. 18, the structure of a disc drive device (recording and reproducing apparatus) that records and reproduces data to and from the discs of the next generation MD1 system and the next generation MD2 system.

FIG. 17 shows a disc drive device 1 that can be connected to a personal computer 100.

The disc drive device 1 comprises a medium drive portion 2, a memory transfer controller 3, a cluster buffer memory 4, an auxiliary memory 5, universal serial bus (USB) interfaces 6 and 8, a USB hub 7, a system controller 9, and an audio process portion 10.

The medium drive portion 2 records and reproduces data to and from a disc 90 loaded into the disc drive device 1. The disc 90 is the disc of the next generation MD1 system, the disc of the next generation MD2 system, or the disc of the conventional MD system. An internal structure of the medium drive portion 2 will be described later with reference to FIG. 18.

The memory transfer controller 3 controls the medium drive portion 2 to send and receive reproduction data and record data.

The cluster buffer memory 4 buffers data that is read from data tracks of the disc 90 in the unit for which one recording block is read at a time by the medium drive portion 2 under the control of the memory transfer controller 3.

The auxiliary memory 5 stores various types of management information and special information that are read from the disc 90 by the medium drive portion 2 under the control of the memory transfer controller 3.

The system controller 9 controls the entire disc drive device 1 and controls communication with the personal computer 100 connected to the disc drive device 1.

In other words, the system controller 9 can communicate with the personal computer 100 connected through the USB interface 8 and the USB hub 7, receives commands such as a write request and a read request and transmits status information and other necessary information.

When the disc 90 is loaded into the medium drive portion 2, the system controller 9 causes the medium drive portion 2 to read management information and so forth from the disc 90. In addition, the system controller 9 causes the medium drive portion 2 to store management information and so forth that has been read under the control of the memory transfer controller 3 to the auxiliary memory 5.

When the system controller 9 receives a read request for a particular FAT sector from the personal computer 100, the system controller 9 causes the medium drive portion 2 to read a recording block including the FAT sector. The memory transfer controller 3 causes data of the recording block that has been read to be written to the cluster buffer memory.

The system controller 9 causes data of the requested FAT sector to be read from data of the recording block written in the cluster buffer memory 4 and the data to be sent to the personal computer 100 through the USB interface 6 and the USB hub 7.

When the system controller 9 receives a write request for a particular FAT sector from the personal computer 100, the system controller 9 causes the medium drive portion 2 to read a recording block including the FAT sector. The memory transfer controller 3 causes the recording block that has been read to be written to the cluster buffer memory 4.

The system controller 9 causes the data of the FAT sector (record data) requested by the personal computer 100 to be sent to the memory transfer controller 3 through the USB interface 6 and the data of the FAT sector to be rewritten in the cluster memory 4.

The system controller 9 causes the memory transfer controller 3 to transfer data of a recording block of which the required FAT sector has been rewritten and stored in the cluster buffer memory 4 as record data to the medium drive portion 2. The medium drive portion 2 modulates the record data of the recording block and rewrites the modulated data to the disc 90.

A switch 50 is connected to the system controller 9. The switch 50 designates an operation mode of the disc drive device 1 to one of the next generation MD1 system and the conventional MD system. In other words, the disc drive device 1 can record audio data to the disc 90 in the format of the conventional MD system and in the format of the next generation MD1 system. The switch 50 allows the user to clearly know the operation mode of the main body of the disc drive device 1. The switch 50 is shown as a mechanical switch. Alternatively, an electric switch, a magnetic switch, or a hybrid type switch may be used.

The disc drive device 1 is provided with a display unit 51 composed of for example a liquid crystal display (LCD). The display unit 51 can display text data and simple icons. The display unit 51 displays information of the state of the disc drive device 1, a message to the user, and so forth in accordance with a display control signal supplied from the system controller 9.

The audio process portion 10 has as input portions an analog audio signal-input portion for such as a line input circuit/microphone input circuit, an A/D converter, and a digital audio data input portion. In addition, the audio process portion 10 has an ATRAC compression encoder/decoder and a compression data buffer memory. Moreover, the audio process portion 10 has as output portions a digital audio data output portion, a D/A converter, and a line output circuit/headset output circuit.

In the case that the disc 90 is a disc of the conventional MD system, when an audio track is recorded on the disc 90, digital audio data (or an analog audio signal) is input to the audio process portion 10. Linear PCM digital audio data that has been input or linear PCM audio data that has been input as an analog audio signal and that has been converted by the A/D converter is encoded in accordance with the ATRAC compression encoding method and stored in the buffer memory. The audio data is read from the buffer memory at predetermined timing (in the unit of data of an ADIP cluster) and then transferred to the medium drive portion 2. The medium drive portion 2 modulates the compressed data in accordance with the EFM method and writes the modulated data as an audio track to the disc 90.

In the case that the disc 90 is a disc of the conventional MD system, when an audio track is reproduced from the disc 90, the medium drive portion 2 demodulates the reproduction data that has been compressed in accordance with the ATRAC modulating method and transfers the demodulated data to the audio process portion 10 through the memory transfer controller 3. The audio process portion 10 decompresses and decodes the data that has been compressed in accordance with the ATRAC compressing method and supplies the decompressed data as linear PCM audio data to the digital audio data output portion. The linear PCM audio data is output from the digital audio data output portion. Alternatively, the digital audio data is supplied to the D/A converter. The D/A converter converts the digital signal into an analog signal and supplies the analog signal to the line output circuit/headset output circuit. The analog audio signal is output from the line output circuit/headset output circuit.

The disc drive device 1 may be connected to the personal computer 100 through another interface such as IEEE (Institute of Electrical and Electronics Engineers) 1394 interface instead of the USB interface. Alternatively, the disc drive device 1 may be connected to the personal computer 100 through for example a radio wave, an infrared ray, or the like instead of a cable.

Record data and reproduction data are managed in accordance with the FAT system. A conversion between a recording block and an FAT sector is described in the specification of Japanese Patent Application No. 2001-289380 that the applicant of the present invention has proposed.

Next, with reference to FIG. 18, a structure of the medium drive portion 2 that has a function for recording and reproducing a data track and an audio track will be described.

FIG. 18 shows the structure of the medium drive portion 2. The medium drive portion 2 has a turntable on which one of the disc of the conventional MD system, the disc of the next generation MD1 system, and the disc of the next generation MD2 system is placed. The medium drive portion 2 causes a spindle motor 29 to drive and rotate the disc 90 placed on the turntable at the CLV. When a recording operation or a reproducing operation is performed, a laser beam is irradiated to the disc 90 by an optical head 19.

When data is recorded on the disc 90, the optical head 19 irradiates laser light having a high level so that a record track is heated at Curie temperature. In contrast, when data is reproduced from the disc 90, the optical head 19 irradiates laser light having a relatively low level so that data is detected from reflected light using magnetic Kerr effect. Thus, the optical head 19 is provided with an optical system composed of a laser diode as a laser output portion, a deflected beam splitter, an objective lens, and so forth and a detector that detects reflected light. The objective lens of the optical head 19 is movably held by for example a two-axis mechanism. The two-axis mechanism moves the objective lens in the radial direction and the direction that the objective lens approaches and goes away from the disc.

The disc 90 is sandwiched by a magnetic head 18 and the optical head 19. The magnetic head 18 applies a magnetic field modulated in accordance with record data to the disc 90. In addition, the medium drive portion 2 is provided with a thread motor and a thread mechanism (not shown). The thread motor and the thread mechanism move the entire optical head 19 and the magnetic head 18 in the radius direction of the disc 90.

When the disc 90 is the disc of the next generation MD2 system, the optical head 19 and the magnetic head 18 perform a pulse-driven magnetic field modulation so as to form a small mark. When the disc 90 is the disc of the conventional MD system or the disc of the next generation MD1 system, the optical head 19 and the magnetic head 18 perform a DC light-emitted magnetic field modulating system.

In addition to a recording and reproducing head system composed of the optical head 19 and the magnetic head 18 and a disc rotating and driving system composed of the spindle motor 29, the medium drive portion 2 is provided with a recording process system, a reproducing process system, a servo system, and so forth.

The disc 90 that is loaded into the medium drive portion 2 may be the disc of the conventional MD system, the disc of the next generation MD1 system, or the disc of the next generation MD2 system. The linear velocities of these discs differ from each other. The spindle motor 29 can be rotated at rotating velocities corresponding to a plurality of types of discs having different linear velocities. The disc 90 placed on the turntable is rotated at the linear velocity of the disc of the conventional MD system, the linear velocity of the disc of the next generation MD1 system, or the linear velocity of the disc of the next generation MD2 system.

The recording process system has a portion that encodes an audio track of the disc 90 that is the disc of the conventional MD system with an error correction code using ACIRC, modulates the encoded data in accordance with the EFM method, and records the modulated data to the disc 90. The recording process portion also has a portion that encodes an audio track of the disc 90 that is the disc of the next generation MD1 system or the disc of the next generation MD2 system with an error correction code in accordance with a combination of BIS and LDC, modulates the encoded data in accordance with 1-7 pp modulating method, and records the modulated data to the disc 90.

The reproducing process system has a portion that demodulates data that has been EFM modulated and reproduced from the disc 90 that is the disc of the conventional MD system and performs an error correcting process using ACIR for the demodulated data. The reproducing process portion has another portion that detects data reproduced from the disc 90 that is the disc of the next generation MD1 system or the disc of the next generation MD2 system in accordance with partial response and Viterbi decoding, performs a 1-7 demodulating process for the detected data, and performs an error correcting process using BIS and LDC for the demodulated data.

The reproducing process system also has a decoding portion that decodes an address of an ADIP signal of the conventional MD system and the next generation MD1 system and another decoding portion that decodes an ADIP signal of the next generation MD2 system.

Information detected as reflected light of a laser irradiation of the optical head 19 to the disc 90 (an optical current detected from reflected light of the laser light by a photo detector) is supplied to an RF amplifier 21.

The RF amplifier 21 performs a current-voltage conversion, an amplification, a matrix calculation, and so forth for detection information that has been input and obtains a reproduction RF signal, a tracking error signal TE, a focus error signal FE, groove information (ADIP information of wobbled grooves as tracks of the disc 90) as reproduction information.

When a reproducing operation is performed for the disc 90 that is the disc of the conventional MD system, the reproduction RF signal obtained by the RF amplifier is processed by an EFM demodulating portion 24 and an ACIRC decoder 25. The EFM demodulating portion 24 digitizes the reproduction RF signal, obtains an EFM signal sequence, and performs an EFM demodulating process for the EFM signal sequence. Thereafter, the ACIRC decoder 25 performs an error correcting process and a de-interleaving process for the demodulated data. At that point, data that has been compressed in accordance with the ATRAC method is obtained.

When a reproducing operation is performed for the disc 90 that is the disc of the conventional MD system, a selector 26 has been placed on a B contact side. The demodulated data that has been compressed in accordance with the ATRAC method is output as reproduction data from the disc 90.

On the other hand, when a reproducing operation is performed for the disc 90 that is the disc of the next generation MD1 system or the disc of the next generation MD2 system, the reproduction RF signal obtained by the RF amplifier is supplied to an RLL (1-7) PP demodulating portion 22 and an RS-LDC decoder 23. The RLL (1-7) PP demodulating portion 22 detects data in accordance with PR (1, 2, 1) ML or PR (1, −1) ML and Viterbi decoding method and obtains reproduction data as an RLL (1-7) code sequence. The RLL (1-7) PP demodulating portion 22 performs an RLL (1-7) demodulating process for the RLL (1-7) code sequence. In addition, the RS-LDC decoder 23 performs an error correcting process and a de-interleaving process for the demodulated data.

When a reproducing operation is performed for the disc 90 that is the disc of the next generation MD1 system or the disc of the next generation MD2 system, the selector 26 has been placed on an A contact side. Thus, the demodulated data is output as reproduction data of the disc 90.

The tracking error signal TE and the focus error signal FE that are output from the RF amplifier 21 are supplied to a servo circuit 27. The groove information that is output from the RF amplifier 21 is supplied to an ADIP demodulating portion 30.

The ADIP demodulating portion 30 extracts a wobble component that has been band-passed by a band pass filter and performs an FM demodulating process and a bi-phase demodulating process for the band-passed wobbled component, and obtains an ADIP signal. The obtained ADIP signal is supplied to address decoders 32 and 33.

As shown in FIG. 10, the ADIP sector number of the disc of the conventional MD system or the disc of the next generation MD1 system has eight digits. In contrast, as shown in FIG. 12, the ADIP sector number of the disc of the next generation MD2 system has four bits. The address decoder 32 decodes the ADIP address of the disc of the conventional MD system or the disc of the next generation MD1 system. The address decoder 33 decodes the ADIP address of the disc of the next generation MD2 system.

The ADIP address decoded by the address decoder 32 or 33 is supplied to a drive controller 31. The drive controller 31 executes a predetermined control process in accordance with the ADIP address. The groove information is supplied to the servo circuit 27 that controls the spindle servo.

The servo circuit 27 generates a spindle error signal with which a servo control is performed at the CLV or CAV in accordance with an error signal obtained by integrating a phase error between for example groove information and a reproduction clock (a PLL clock with which data is decoded).

In addition, the servo circuit 27 generates various types of servo control signals (for example, a tracking control signal, a focus control signal, a thread control signal, and a spindle control signal) in accordance with the spindle error signal; the tracking error signal and the focus error signal supplied from the RF amplifier 21; and various types of commands (for example, a track jump command and an access command) supplied from the drive controller 31 and outputs the generated signals to a motor driver 28. In other words, the servo circuit 27 performs required processes such as a phase compensation process, a gain process, and a target value setting process in accordance with the servo error signals and commands so as to generate various types of servo control signals.

The motor driver 28 generates a predetermined servo drive signal in accordance with the servo control signals supplied from the servo circuit 27. The servo drive signals are two-axis drive signals (in focus direction and tracking direction) with which the two-axis mechanism is driven, a thread motor drive signal with which the thread mechanism is driven, and a spindle motor drive signal with which the spindle motor 29 is driven. With these servo drive signals, the focus control and tracking control for the disc 90 and the CLV control or CAV control for the spindle motor 29 are performed.

When audio data is recorded to the disc of the conventional MD system, a selector 16 is connected to a B contact thereof. Thus, an ACIRC encoder 14 and an EFM modulating portion 15 operate. In this case, the ACIRC encoder 14 performs an interleaving process and an error correction code adding process for compressed data supplied from the audio process portion 10. Thereafter, the EFM modulating portion 15 modulates the data that is output from the ACIRC encoder 14 in accordance with the EFM method.

The EFM modulated data is supplied to a magnetic head driver 17 through the selector 16. The magnetic head 18 applies a magnetic field to the disc 90 in accordance with the EFM modulated data. As a result, audio tracks are recorded on the disc 90.

When data is recorded to the disc of the next generation MD1 system or the disc of the next generation MD2 system, the selector 16 is connected to an A contact thereof. Thus, an RS-LDC encoder 12 and an RLL (1-7) PP modulating portion 13 operate. In this case, the RS-LDC encoder 12 interleaves high density data received from the memory transfer controller 3 and adds an error correction code to the interleaved data in accordance with the RS-LDC system. Thereafter, the RLL (1-7) PP modulating portion 13 modulates the data that is output from the RS-LDC encoder 12 in accordance with the RLL (1-7) modulation method.

Record data as an RLL (1-7) code sequence is supplied to the magnetic head driver 17 through the selector 16. The magnetic head 18 applies a magnetic field to the disc 90 in accordance with the modulated data. As a result, data tracks are recorded.

A laser driver/APC 20 causes the laser diode to irradiate laser light and performs so-called automatic laser power control (APC) when a reproducing operation and a recording operation are preformed.

The optical head 19 has a detector (not shown) that monitors a laser power. The detectors outputs a monitor signal. The monitor signal is fed back to the laser driver/APC 20. The laser driver/APC 20 compares the current laser power obtained as the monitor signal with the laser power that has been set and reflects the error to the laser drive signal so that the laser power of the laser diode becomes stable with the value that has been set.

The drive controller 31 sets values of a reproduction laser power and a record laser power to an internal register of the laser driver/APC 20.

The drive controller 31 controls the foregoing operations (accessing operation, various servo operations, data writing operation, and data reading operation) in accordance with commands received from the system controller 9.

In FIG. 18, blocks A and B surrounded by dotted lines can be structured as for example one-chip circuit portions.

5. Initializing Processes for Discs of Next Generation MD1 System and Next Generation MD2 System

On the disc of the next generation MD1 system and the disc of the next generation MD2 system, the unique ID (UID) is recorded along with the FAT. With the recorded UID, security for data recorded thereon is managed. On the disc of the next generation MD1 system and the disc of the next generation MD2 system, the UID is recorded at a predetermined position before it is shipped. On the disc of the next generation MD1 system, the UID is recorded in for example the lead-in area before it is shipped. Alternatively, the UID may be recorded in other than the lead-in area as long as the position of the UID is fixed after the disc is initialized. On the disc of the next generation MD2 system and the disc of the next generation MD 1.5 system, the UID is recorded in the foregoing BCA.

On the other hand, the disc of the conventional MD system can be used instead of the disc of the next generation MD1 system. Thus, many discs that are used for the conventional MD system and that do not have the UID will be used for the discs of the next generation MD1 system.

Thus, for the discs that are used for the conventional MD system and that do not have UID, an area that complies with the standard is formed. When the disc drive device 1 initializes the disc, the device 1 records a random number signal to the area. The recorded random number signal is used as the UID of the disc. The standard should prohibit the user from accessing the area for the UID. It should be notated that the UID is not limited to a random number signal. Alternatively, a combination of a maker code, a machine code, a machine serial number, and a random number may be used as the UID. Alternatively, a combination of at least one of a maker code, a machine code, and a machine serial number and a random number may be used as the UID.

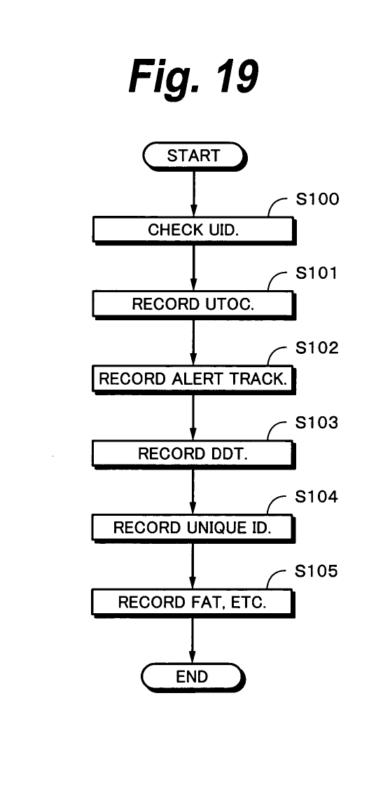

FIG. 19 is a flow chart showing an example of an initializing process for the disc of the next generation MD1 system. At step S100, a predetermined position of the disc is accessed. It is determined whether or not the UID has been recorded. When the determined result represents that the UID has been recorded, the UID is read and temporarily stored in for example the auxiliary memory 5.

The position accessed at step S100 is for example the lead-in area, not the area for the FAT in the format of the next generation MD1 system. When the DDT has been formed like a disc that has been initialized, the area may be accessed. Step S100 may be omitted.

Thereafter, at step S101, the U-TOC is EFM-modulated and recorded. At that point, after the U-TOC, an alert track and tracks preceded by the DDT shown in FIG. 2, namely information with which an area for 1-7 pp modulated data is allocated are written. At step S102, the alert track that has been EFM modulated is recorded to the area allocated with the U-TOC. At step S103, the DDT is 1-7 pp modulated and recorded.

At step S104, the UID is recorded in an area other than the FAT, for example the DDT. When the UID has been read from the predetermined position of the disc and stored in the auxiliary memory 5, at step S100, the UID is recorded. When the determined result at step S100 represents that the UID has not been recorded at the predetermined position of the disc or step S100 is omitted, the UID is generated in accordance with a random number signal. The generated random number is recorded. The UID is generated by for example the system controller 9. The generated UID is supplied to the medium drive portion 2 through the memory transfer controller 3 and recorded to the disc 90.

Thereafter, at step S105, data such as the FAT is 1-7 pp modulated and recorded to the predetermined area. In other words, the area for the UID is an area other than the FAT. In addition, as described above, for the disc of the next generation MD1 system, it is always necessary to initialize a recordable area managed in accordance with the FTA.

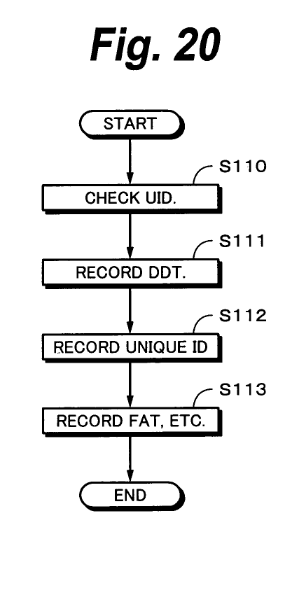

FIG. 20 is a flow chart showing an example of an initializing process for the disc of the next generation MD2 system and the disc of the next generation MD 1.5 system. At step S110, an area for the BAC on the disc is accessed. It is determined whether or not the UID has been recorded. When the determined result represents that the UID has been recorded, the UID is read and temporarily stored to the auxiliary memory 5. The recording position of the UID is fixed in accordance with the standard. Thus, without need to reference other management information on the disc, the UID can be directly accessed. This operation applies to the process described with reference to FIG. 19.

At step S111, the DDT is 1-7 pp modulated and recorded. At step S112, the UID is recorded in an area for example the DDT, not the area for the FAT. At that point, the UID that has been read from a predetermined position of the disc and stored in the auxiliary memory 5 is used. When the determined result at step S110 represents that the UID has not been recorded in the predetermined position of the disc, the UID is generated in accordance with a random number signal. The generated UID is recorded. The UID is generated by for example the system controller 9. The generated UID is supplied to the medium drive portion 2 through the memory transfer controller 3 and recorded to the disc 90.

At step S113, the FAT and so forth are recorded. In other words, the area for the UID is outside the area of the FAT. In addition, as described above, for the disc of the next generation MD2 system, the generated UID is supplied to the medium drive portion 2 through the memory transfer controller 3 and the generated UID is recorded to the disc 90.

6. First Managing System for Music Data

As described above, the next generation MD1 system and the next generation MD2 system according to the embodiment of the present invention manage data in accordance with the FAT system. In addition, these MD systems compresses audio data that is recorded in accordance with a predetermined compression system. The MD system also encrypt compressed audio data to protect a right of the copyright owner. As a compression system for audio data, it is assumed that for example ATRAC3, ATRAC5, or the like is used. Of course, another compression system such as MPEG1 audio layer-3 (MP3) system or MPEG2 advanced audio coding (AAC) system may be used. In addition, these MD systems can deal with still picture data and moving picture data as well as audio data. Of course, since these MD systems use the FAT system, they can record and reproduce general purpose data. In addition, a command that can be read and executed by a computer may be encoded and recorded on the disc of these MD systems. Thus, executable files can be recorded to the discs of these MD systems.

Next, a managing system that manages audio data that is recorded and reproduced to and from the disc of the next generation MD1 system and the disc of the next generation MD2 system will be described.

Since the next generation MD1 system and the next generation MD2 system can reproduce music data for long duration with high quality, the number of songs managed by one disc is large. In addition, since the disc of the next generation MD1 system and the disc of the next generation MD2 system manages are managed in accordance with the FAT system, they have affinity with a computer. The inventor of the present invention recognizes that although these discs provide the user with improved operability, since they allow him or her to illegally copy contents, there is a risk of which their copyright cannot be properly protected. Thus, the managing system according to the present invention considers such a point.

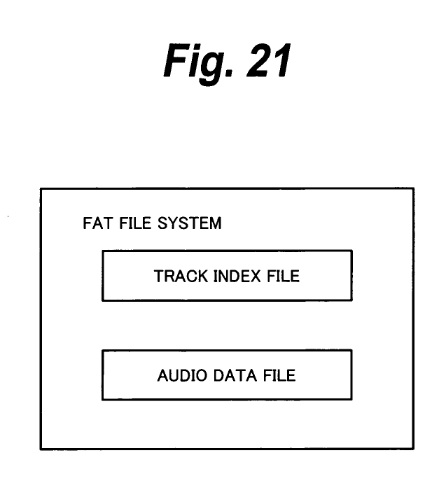

FIG. 21 shows a first example of the managing system for audio data. As shown in FIG. 21, in the first example of the managing system, a track index file and an audio data file are created. The track index file and the audio data file are managed in accordance with the FAT system.

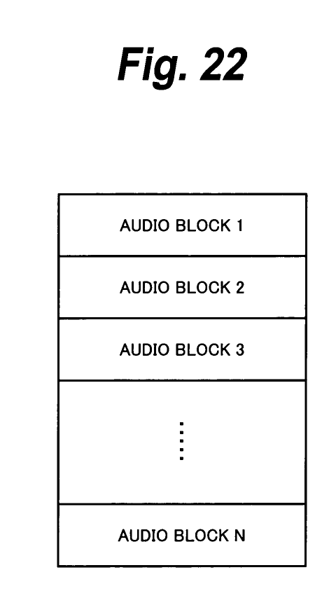

As shown in FIG. 22, an audio data file contains a plurality of tracks of music data. The FAT system treats an audio data file as a jumbo file. The FAT system delimits audio data file as parts and treats it as a set of parts.

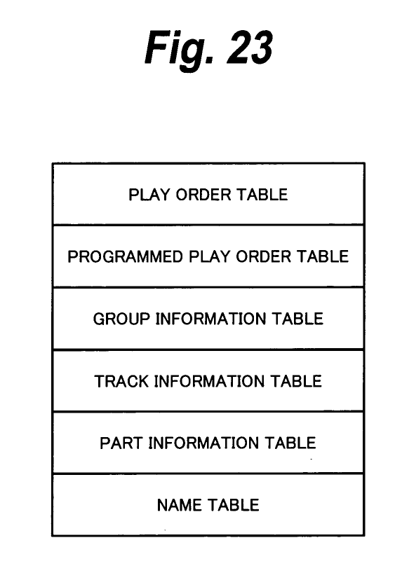

A track index file describes various types of information with which music data contained in an audio data file is managed. As shown in FIG. 23, the track index file is composed of a play order table, a programmed play order table, a group information table, a track information table, a part information table, and a name table.

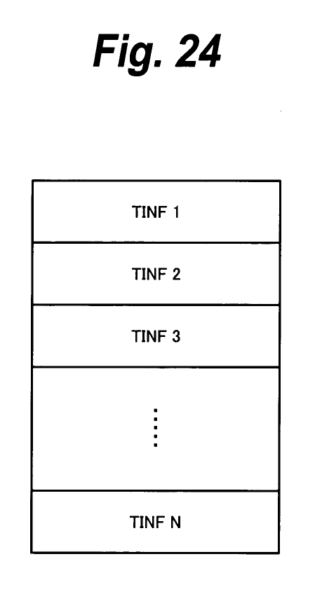

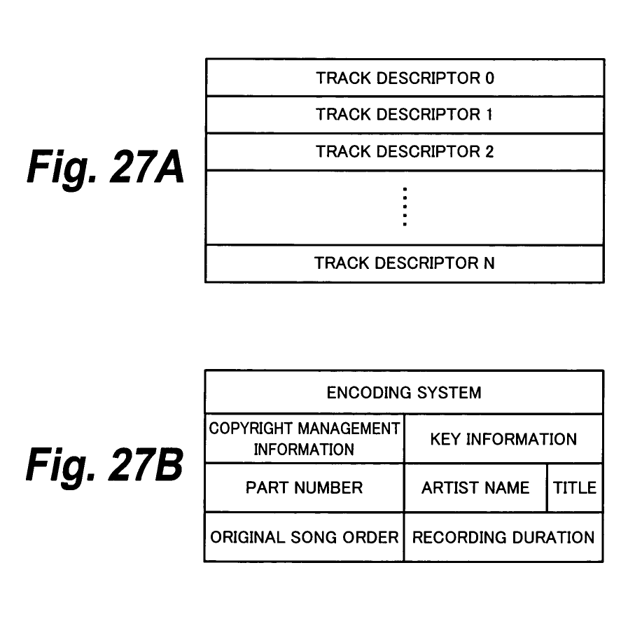

The play order table describes a default reproduction order of the music data. As shown in FIG. 24, the play order table describes information TINF1, TINF2, . . . that are pointers to track descriptors (FIG. 27A and FIG. 27B) of the track information table corresponding to track numbers (song numbers). The track number starts from for example “1”.

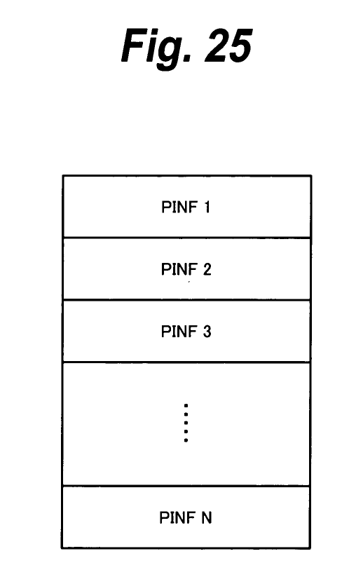

The programmed play order table describes a reproduction order of the music data defined by the user. As shown in FIG. 25, the programmed play order table describes track information PINF1, PINF2, that are pointers to track descriptors according to track numbers.

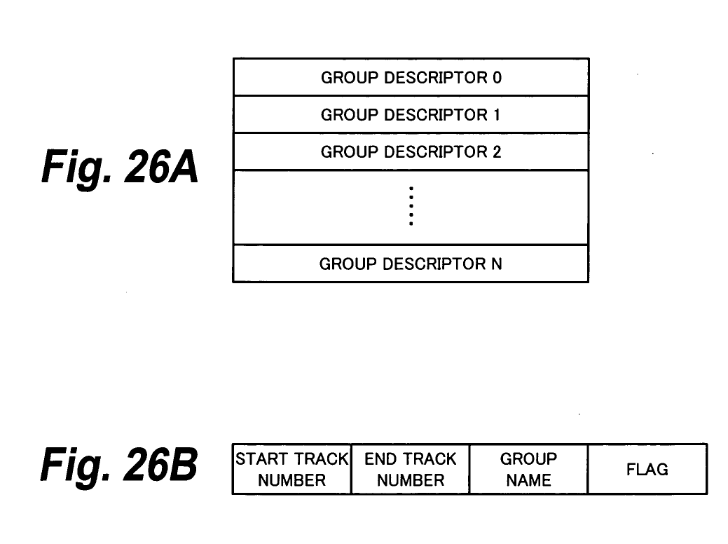

As shown in FIG. 26A and FIG. 26B, the group information table describes information about groups. A group is a set of a plurality of tracks having successive track numbers. Alternatively, a group is a set of at least one track having successively programmed track numbers. As shown in FIG. 26A, the group information table describes group descriptors according to groups. As shown in FIG. 26B, a group descriptor describes a start track number, an end track number, a group name, and a flag.

As shown in FIG. 27A and FIG. 27B, the track information table describes information about each song (track). As shown in FIG. 27A, the track information table is composed of track descriptors corresponding to tracks (songs). As shown in FIG. 27B, each track descriptor describes an encoding system, copyright management information, decryption key information of the content, pointer information to a part number that is an entry with which the song starts, an artist name, a title name, original song order information, recording duration information, and so forth. The artist name and the title name describe pointer information to the name table, not names themselves. The encoding system represents a codec system as decoding information.

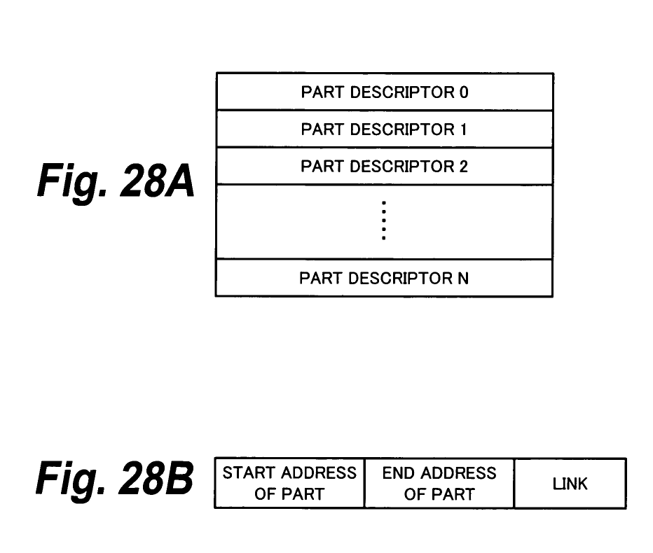

As shown in FIG. 28A and FIG. 28B, the part information table describes a pointer to the position of a real song corresponding to a part number. As shown in FIG. 28A, the part information table is composed of part descriptors corresponding to parts. A part represents an entire track (song) or a part of one track. FIG. 28B shows entries of a part descriptor of the part information table. As shown in FIG. 28B, a part descriptor describes a start address of the part of the audio data file, an end address of the part, and a rink (pointer) to the next part.

As addresses used as pointer information of a part number, pointer information of a name table, and pointer information of the position of an audio file, a byte offset of a file, a part descriptor number, a cluster number of the FAT, a physical address of a disc used as a recording medium, and so forth can be used. The byte offset of the file is an offset method according to an embodiment of the present invention. The part pointer information is an offset value from the beginning of an audio file. The value of the part pointer information is represented in a predetermined unit (for example, byte, bit, or a block of n bits).

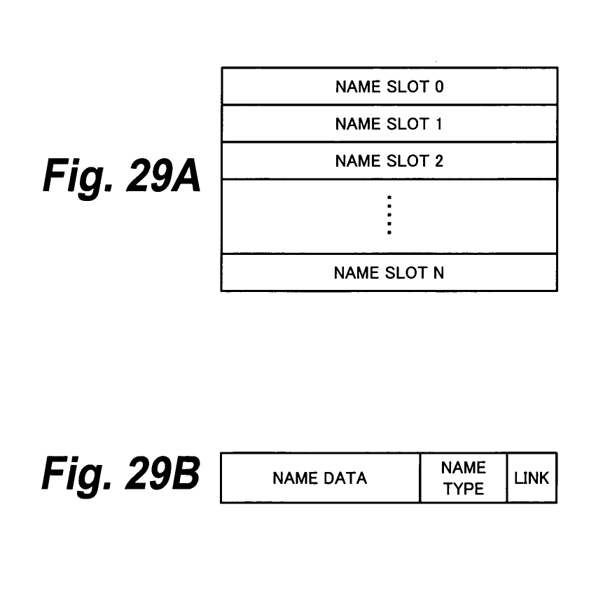

The name table describes characters as an entity of a name. As shown in FIG. 29A, the name table is composed of a plurality of name slots. Each name slot is linked from each pointer that represents a name. Pointers to a name are an artist name and a title name of the track information table, a group name of the group information table, and so forth. Each name slot can be lined from a plurality of pointers. As shown in FIG. 29B, each name slot is composed of name data as character information, a name type as an attribute of the character information, and a link. When a name is long and all characters thereof cannot be placed in one name slot, they are divided and placed in a plurality of name slots. When all characters of a name cannot be placed in one name slot, a link to the next name slot is described.

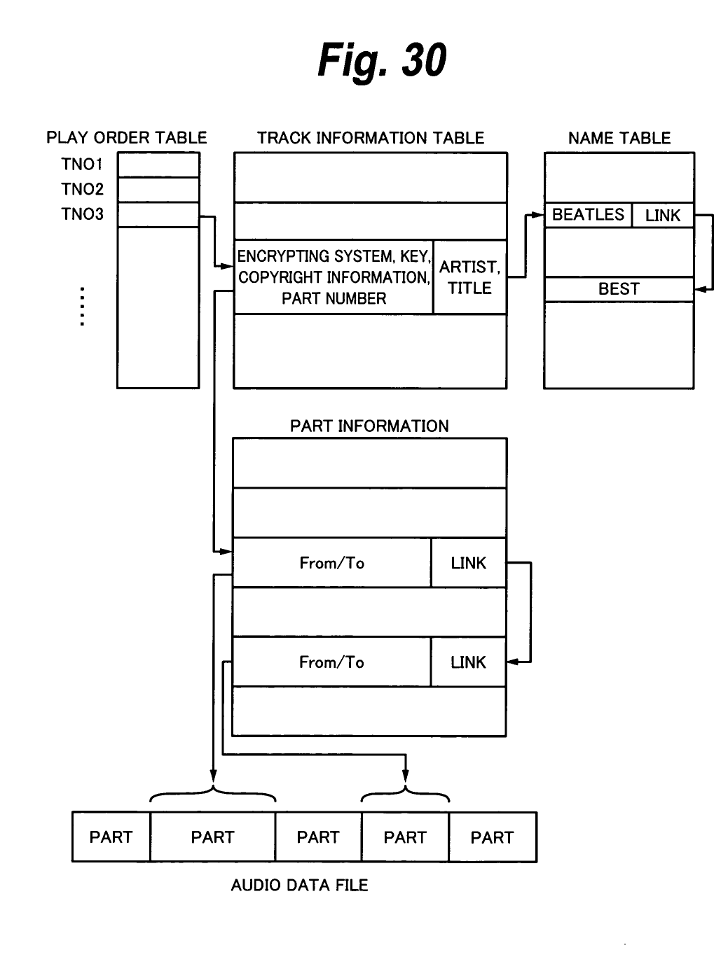

In the first example of the managing system for audio data according to the present invention, when a track number from which a reproducing operation is performed is designated on the play order table (FIG. 24), a track descriptor (FIG. 27A and FIG. 27B) to be linked is read from the track information table as shown in FIG. 30. An encoding system, copyright management information, decryption key information of the content, pointer information to a part number from which the song starts, a pointer to an artist name, a pointer to a title name, original song order information, recording duration information, and so forth are read from the track descriptor.

The part information table (FIG. 28) is linked in accordance with information of a part number that is read from the track information table. An audio data file at the position of a part corresponding to the start position of the track (song) is accessed from the part information table. When data of the part at the position designated on the part information table is accessed, a reproducing operation of the audio data is started from the designated position. At that point, the audio data is decoded in accordance with the encoding system described in the track descriptor. When audio data has been encrypted, the key information that is read from the track descriptor is used.

When the part is followed by another (next) part, a link (pointer) to the next part is described in the part descriptor. Part descriptors are successively read in accordance with links. Audio data of parts designated by part descriptors is reproduced from the audio data file in the order of the links. As a result, audio data of a desired track (song) is reproduced.

A name slot (FIG. 29) is called from the name table corresponding to the artist name pointer and title name pointer (name pointer information) to the track information table. Name data is read from the name slot. Name pointer information may be a name slot number, a cluster number of the FAT system, or a physical address of the recording medium.

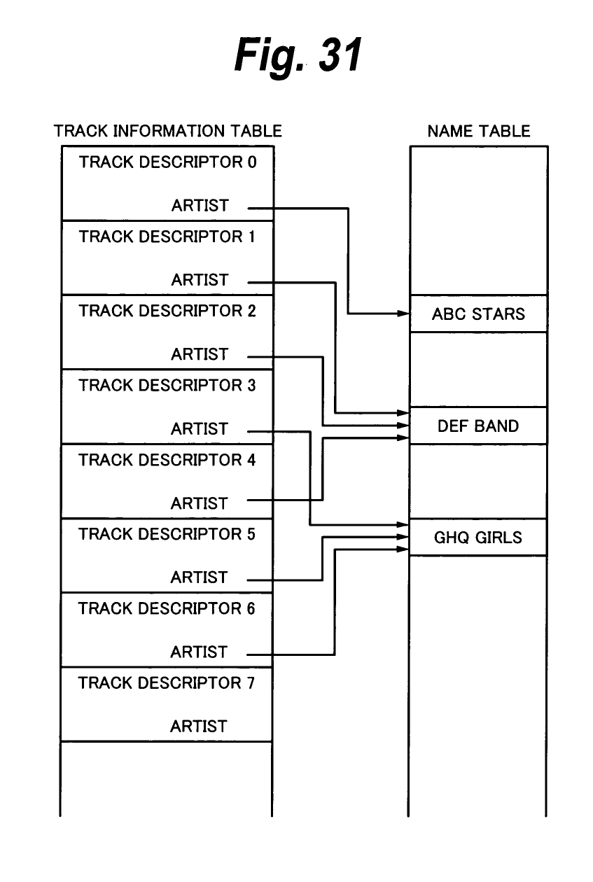

As described above, a name slot of the name table can be referenced from a plurality of pointers. For example, a plurality of songs of one artist may be recorded. In this case, as shown in FIG. 31, the same name table as an artist name is referenced from a plurality of track information tables. In the example shown in FIG. 31, a track descriptor “1”, a track descriptor “2”, and a track descriptor “4” represent songs of an artist “DEF BAND”. Thus, as an artist name, the same name slot is referenced. Likewise, a track descriptor “3”, a track descriptor “5”, and a track descriptor “6” represent songs of an artist “GH GIRLS”. As a result, as an artist name, the same name slot is referenced. Thus, when a name slot of the name table can be referenced from a plurality of pointers, the capacity of the name table can be decreased.

In addition, information of the same artist name can be displayed using a link to the name table. To display a list of songs of the artist name “DEF BAND”, track descriptors that reference the address of the name slot “DEF BAND” are traced. In this example, when track descriptors that reference the address of the name slot “DEF BAND” are traced, information of the track descriptor “1”, the track descriptor “2”, and the track descriptor “4” are obtained. Thus, a list of songs of the artist name “DEF BAND” recorded on the disc is displayed. Since the name table can be referenced from a plurality of pointers, a reverse link traced from the name table to the track information table is not provided.

When audio data is newly recorded, an unused area of more than a predetermined number of successive recording blocks for example more than four successive recording blocks is allocated on the FAT. In other words, since an area of a predetermined number of successive recording blocks is allocated, data can be accessed without a loss.

When the area for audio data is allocated, one new track descriptor is assigned to the track information table. A content key with which the audio data is encrypted is created. With the content key, the input audio data is encrypted. The encrypted audio data is recorded in the allocated unused area. The area for the audio data is connected to the end of the audio data file on the FAT.

After the new audio data is connected to the audio data file, information of the connected position is created. The position information of the newly recorded audio data is described in the newly assigned part descriptor. In addition, key information and a part number are described in the newly assigned track descriptor. In addition, when necessary, an artist name, a title name, and so forth are described in the name slot. The pointers of the artist name and the title name to the name slot are described in the track descriptor. The track descriptor number is registered to the play order table. In addition, the copyright management information is updated.

When audio data is reproduced, information corresponding to a designated track number is obtained from the play order table. As a result, a track descriptor of the track to be reproduced is obtained.

Key information is obtained from a track descriptor of the track information table. In addition, a part descriptor that represents an area for data corresponding to the entry is obtained. The start position of a part of desired audio data of the audio data file is obtained from the part descriptor. Data is obtained from the position of the part. The data reproduced from the position is decrypted with the obtained key information. As a result, the audio data is reproduced. When the part descriptor describes a link to a part, it is linked and the same process is repeated.

When a track number “n” of a song is changed to a track number “n+m” on the play order table, a track descriptor Dn that describes information of the track is obtained from track information TINFn of the play order table. Values of all the track information TINFn+1 to TINFn+m (track descriptor number) are decreased by 1 each. The track descriptor number Dn is described in the track information TINFn+m.

When the song having the track number “n” is deleted from the play order table, the track descriptor Dn that describes information of the track is obtained from the track information TINFn of the play order table. All valid track descriptor numbers after an entry TINFn+1 of track information of the play order table are decreased by 1 each. In addition, since the track “n” should be deleted, all entries of track information after the track “n” are moved backward by 1 on the play order table. An encoding system and a decryption key are obtained from the track information table in accordance with the track descriptor Dn that is obtained after the track is deleted. In addition, the number of the part descriptor Pn that represents an area for the beginning of music data is obtained. An audio block designated by the part descriptor Pn is removed from the audio data file on the FAT. In addition, the track descriptor Dn of the track is deleted from the track information table. The part descriptor is deleted from the part information table. As a result, the part descriptor is deallocated from the FAT file system.

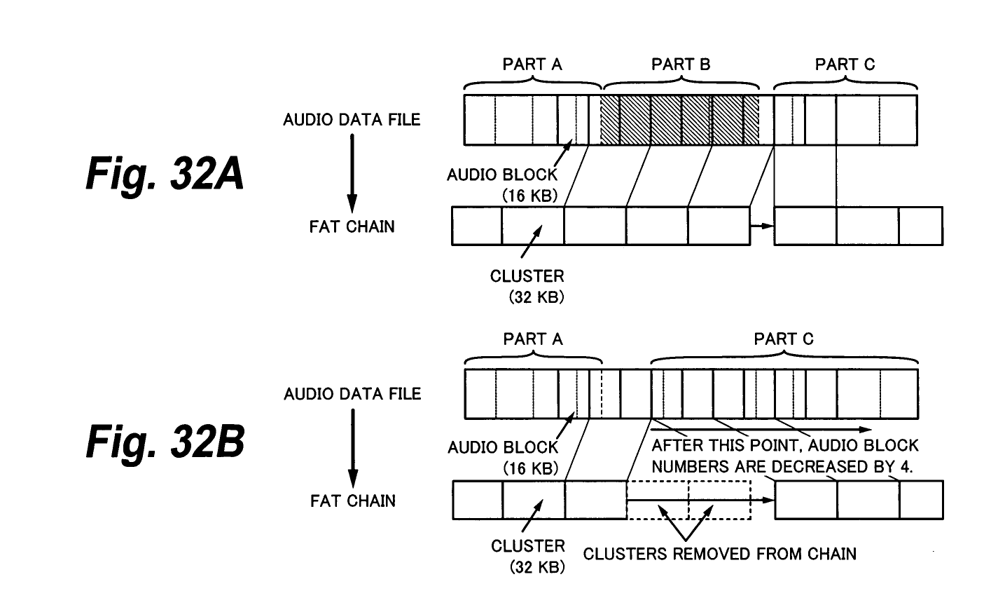

In FIG. 32A, it is assumed that a part A, a part B, and a part C are connected and that the part B is deleted therefrom. In addition, it is assumed that the part A and the part B share the same audio block (same FAT cluster) and that they are successively chained on the FAT. It is assumed that in the audio data file, the part C is immediately preceded by the part B. However, it is assumed that the part C and the part B are spaced apart on the FAT table.

In the example, as shown in FIG. 32B, when the part B is deleted, two FAT clusters that are not shared by the part B are removed from the FAT (deallocated). In other words, four audio blocks of the audio data file are deleted. The block numbers after the part C are decreased by 4 each.

Instead of a part, one entire track can be deleted. When a part of a track is deleted, the rest of the track can be decoded and decrypted in accordance with the encoding system and the decryption key of the track obtained from the part descriptor Pn of the track information table.

When a track n and a track n+1 are connected on the play order table, the track descriptor number Dn that describes information of the track is obtained from track information TINFn of the play order table. In addition, the track descriptor number Dm that describes information of the track is obtained from track information TINFn+1 of the play order table. All valid TINF values (track descriptor numbers) after TINFn+1 of the play order table are decreased by 1 each. All tracks that reference the track descriptor Dm are searched from the programmed play order table and the obtained tracks are deleted. A new encryption key is created. A list of part descriptors is obtained from the track descriptor Dn. The list of part descriptors obtained from the track descriptor Dm is connected to the end of the list of the part descriptors.

When tracks are connected, it is necessary to compare track descriptors thereof, check no copyright management problem, obtain part descriptors from the track descriptors, and determine whether or not the connected tracks satisfy requirements about fragments on the FAT table. When necessary, it is necessary to update pointers to the name table.

When a track n is divided into a new track n and a track n+1, a track descriptor number Dn that describes information of the track n is obtained from TINFn of the play order table. In addition, a track descriptor number Dm that describes information of the track n+1 is obtained from track information TINFn+1 of the play order table. All values (track descriptor numbers) of valid track information after TINFn+1 of the play order table are increased by 1 each. A new key for the track descriptor Dn is created. A list of part descriptors is obtained from the track descriptor Dn. New part descriptors are assigned. The contents of the part descriptors of the track that has not been divided are copied to the new part descriptors. Part descriptors after the divided point deleted. Links to part descriptors after the divided point are removed. A new part descriptor is placed immediately after the divided point.

7. Second Example of Managing System for Music Data

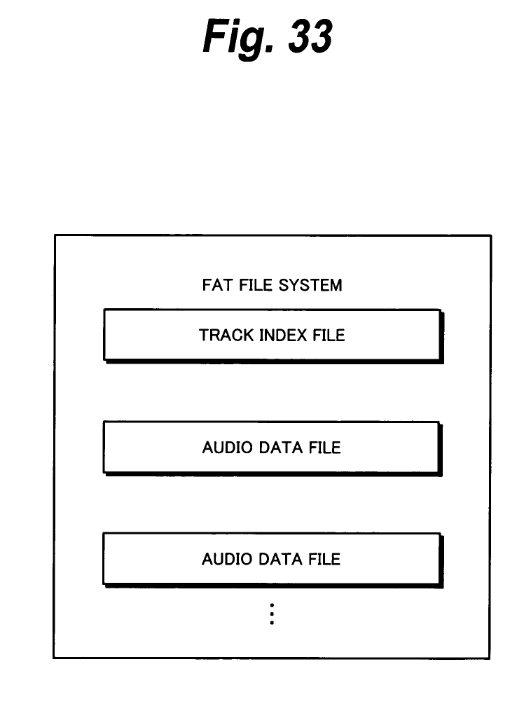

Next, a second example of the managing system for audio data will be described. FIG. 33 shows the second example of the managing system for audio data. As shown in FIG. 33, in the second example of the managing system, a track index file and a plurality of audio data files are created on the disc. The track index file and the plurality of audio data files are managed by the FAT system.

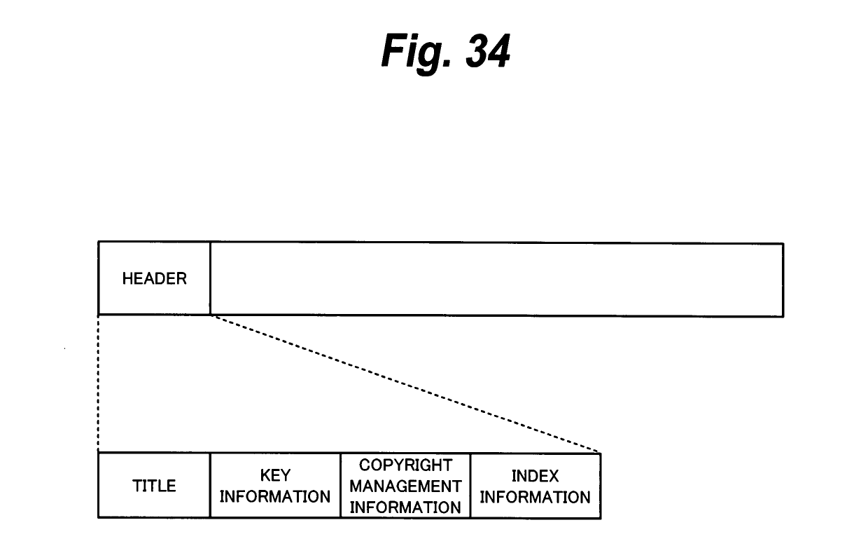

As shown in FIG. 34, an audio data file normally contains one song of music data. The audio data file has a header. The header describes a title, decryption key information, and copyright management information. In addition, the header describes index information. The index serves to divide one track into a plurality of portions. The header describes positions of portions divided by the index in accordance with index numbers. With the index, up to 255 portions can be designated.

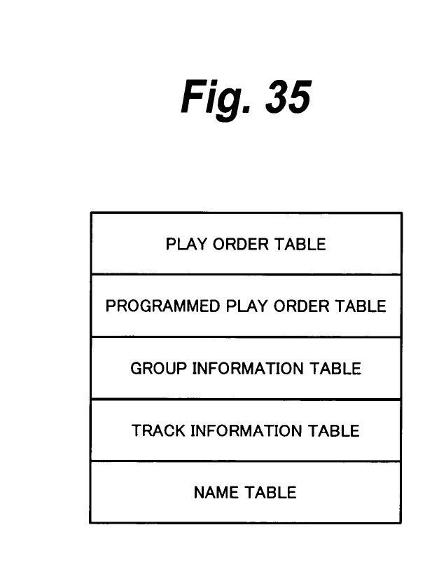

The track index file describes various types of information with which music data contained in an audio data file is managed. As shown in FIG. 35, the track index file is composed of a play order table, a programmed play order table, a group information table, a track information table, and a name table.

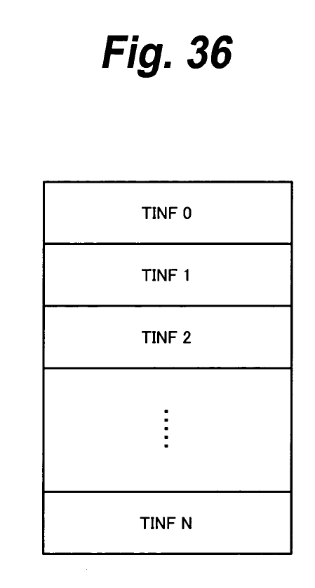

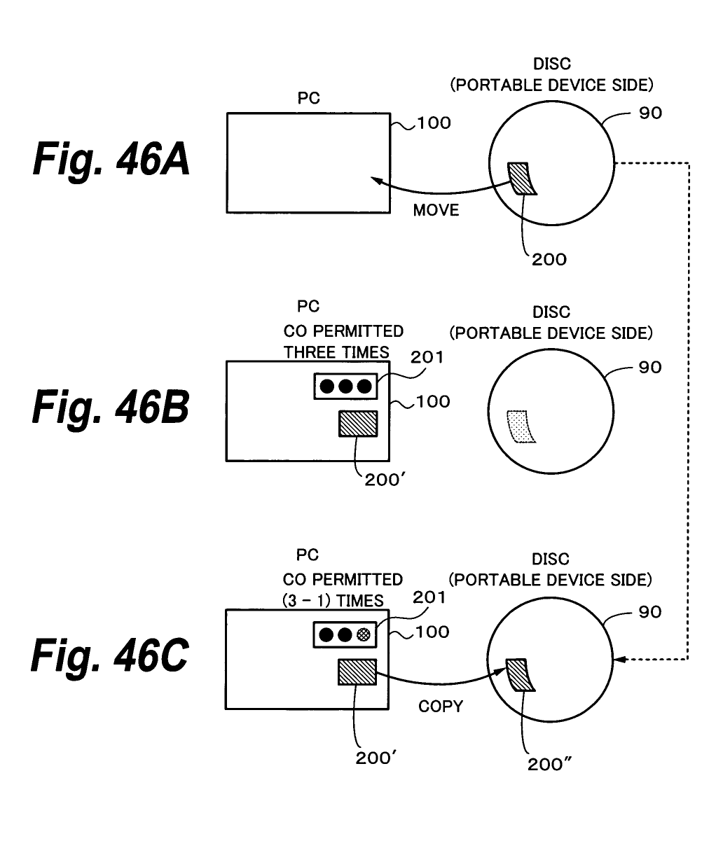

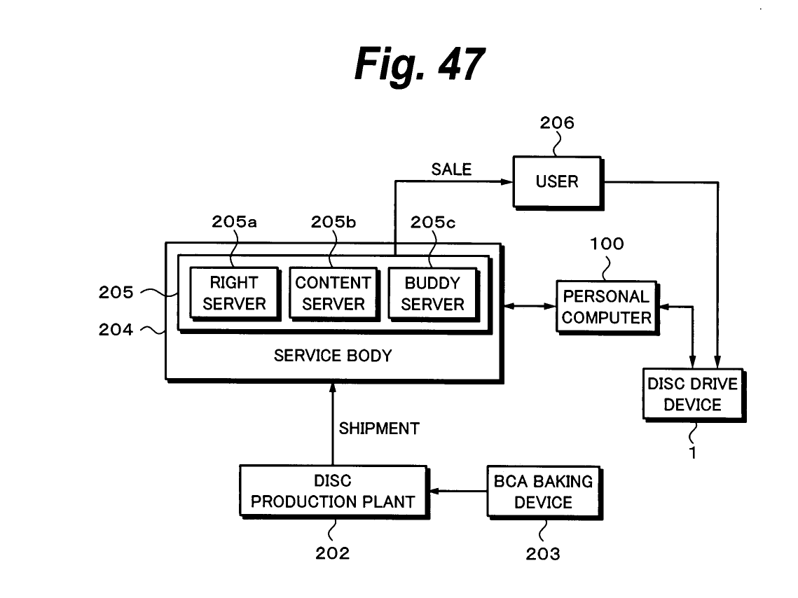

The play order table describes a default reproduction order of the music data. As shown in FIG. 36, the play order table describes information TINF1, TINF2, . . . that are pointers to track descriptors (FIG. 46) of the track information table corresponding to track numbers (song numbers). The track number starts from for example “1”.

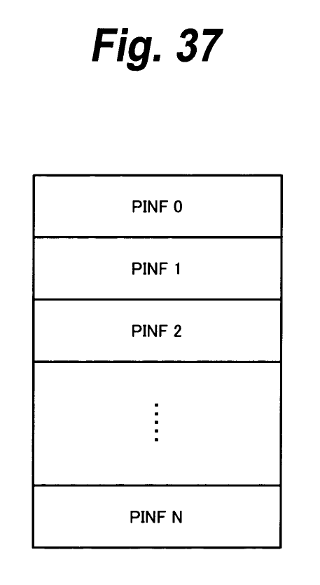

The programmed play order table describes a reproduction order of the music data defined by the user. As shown in FIG. 37, the programmed play order table describes track information PINF1, PINF2, that are pointers to track descriptors according to track numbers.

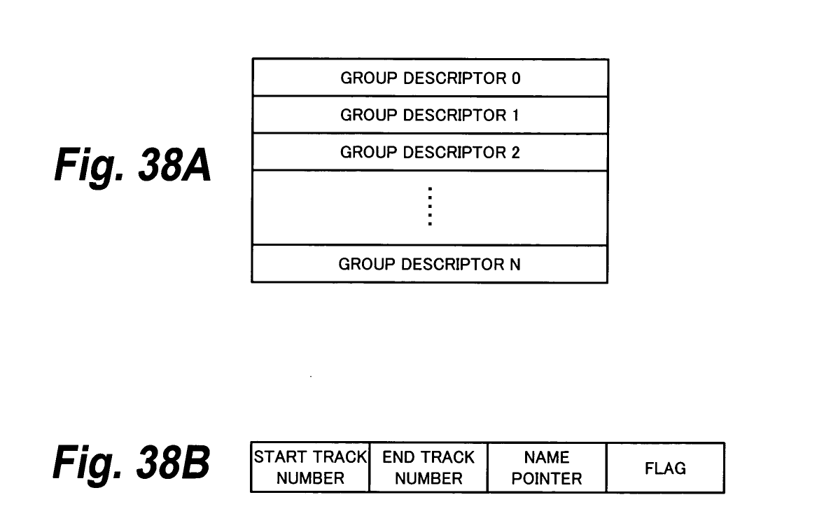

As shown in FIG. 38A and FIG. 38B, the group information table describes information about groups. A group is a set of a plurality of tracks having successive track numbers. Alternatively, a group is a set of at least one track having successively programmed track numbers. As shown in FIG. 38A, the group information table describes group descriptors corresponding to groups. As shown in FIG. 38B, a group descriptor describes a start track number, an end track number, a group name, and a flag.

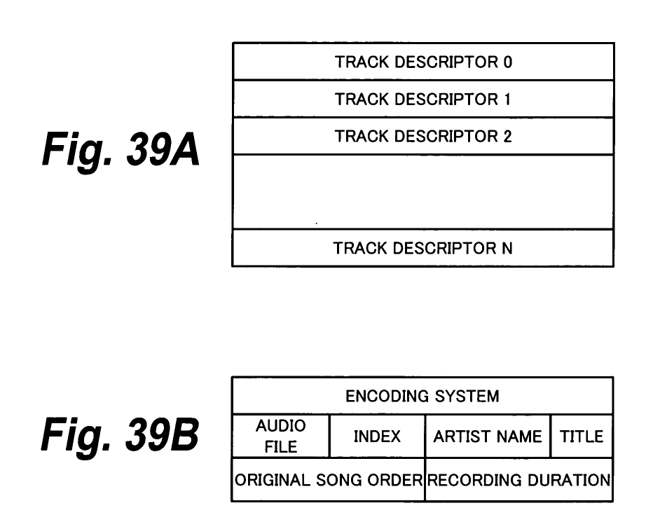

As shown in FIG. 39A and FIG. 39B, the track information table describes information about each song (track). As shown in FIG. 39A, the track information table is composed of track descriptors corresponding to tracks (songs). As shown in FIG. 39B, each track descriptor describes a pointer to an audio data file of the song, an artist name, a title name, original song order information, recording duration information, and so forth. The artist name and the title name describe pointers to the name table, not names themselves.

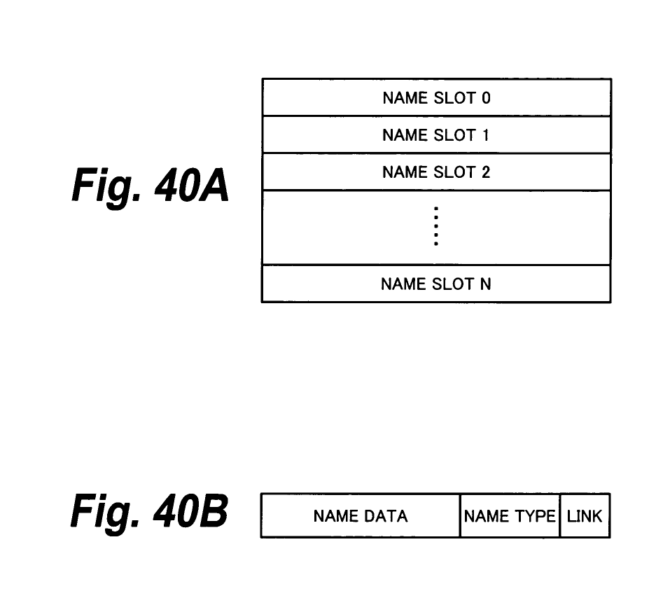

The name table describes characters as an entity of a name. As shown in FIG. 40A, the name table is composed of a plurality of name slots. Each name slot is linked from each pointer that represents a name. Pointers to a name are an artist name and a title name of the track information table, a group name of the group information table, and so forth. Each name slot can be lined from a plurality of pointers. As shown in FIG. 40B, each name slot is composed of name data, a name type, and a link. When a name is long and all characters thereof cannot be placed in one name slot, they are divided and placed in a plurality of name slots. When all characters of a name cannot be placed in one name slot, a link to the next name slot is described.

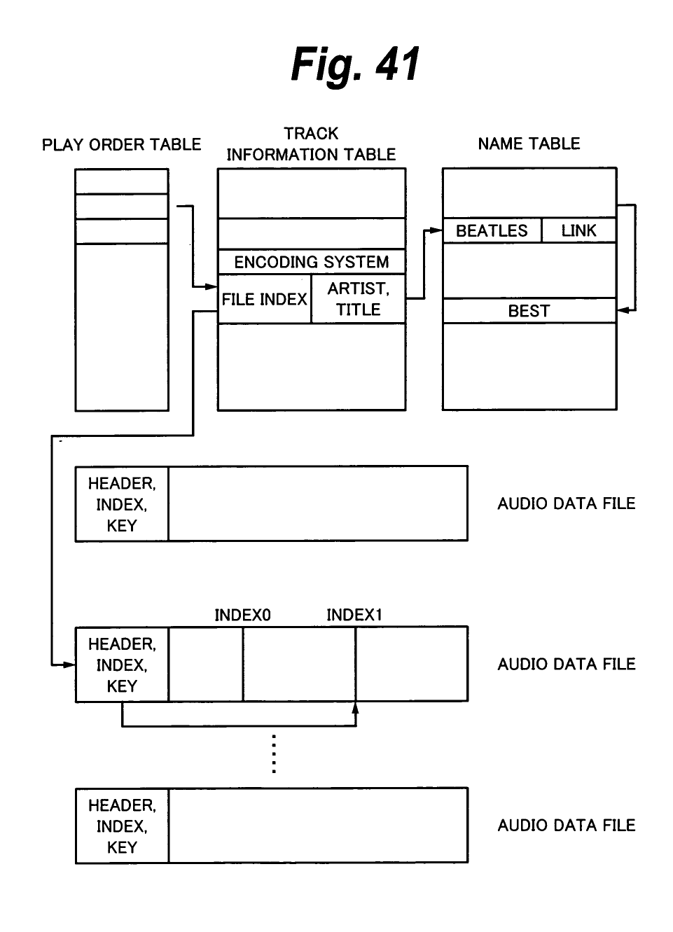

In the second example of the managing system for audio data according to the present invention, when a track number from which a reproducing operation is performed is designated on the play order table (FIG. 36), a track descriptor (FIG. 39A and FIG. 39B) to be linked is read from the track information table as shown in FIG. 41. A file pointer of the song, an index number, pointers to an artist name and a title name, original song order information, recording duration information, and so forth are read from the track descriptor.

The audio data file is accessed with the pointer to the file of the song. As a result, information of the header of the audio data file is read. When the audio data has been encrypted, key information that is read from the header is used. With the key information, the audio data file is reproduced. At that point, if an index number has been designated, the position of the designated index number is detected with information of the header. The audio data file is reproduced from the position of the index number.

A name slot of the name table is called from the position designated by pointers of the artist name and title name that are read form the track information table. The name data is read from the name slot.

When audio data is newly recorded, an unused area of more than a predetermined number of successive recording blocks for example more than four successive recording blocks is allocated on the FAT.

When the area for audio data is allocated, one new track descriptor is assigned to the track information table. A content key with which the audio data is encrypted is created. With the content key, the input audio data is encrypted. As a result, an audio data file is created.

A file pointer to the newly created file and key information are described in the newly allocated track descriptor. In addition, when necessary, the artist name, title name, and so forth are described in the name slot. Pointers of the artist name and the title name to the name slot are described in the track descriptor. The track descriptor number is registered to the play order table. In addition, the copyright management information is updated.

When audio data is reproduced, information corresponding to a designated track number is obtained from the play order table. As a result, a track descriptor of the track to be reproduced is obtained.

A file pointer to audio data that contains the music data and an index number are obtained from the track descriptor. The audio data file is accessed. Key information is obtained from the header of the file. With the obtained key information, the data of the audio data file is decrypted. As a result, the audio data is reproduced. When an index number has been designated, the audio data is reproduced from the position of the designated index number.

When a track n is divided into a new track n and a track n+1, a track descriptor number Dn that describes information of the track n is obtained from TINFn of the play order table. In addition, a track descriptor number Dm that describes information of the track n+1 is obtained from track information TINFn+1 of the play order table. All values (track descriptor numbers) of valid track information after TINFn+1 of the play order table are increased by 1 each.

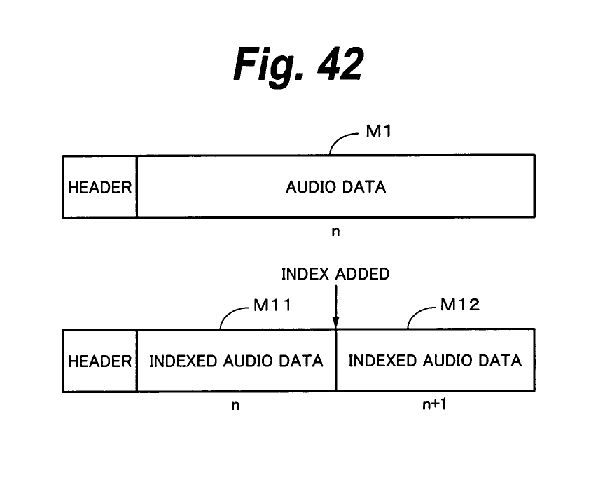

As shown in FIG. 42, when the index is used, data of one file can be divided into a plurality of indexed areas. The index number and the position of the indexed area are described in the header of the audio track file. The track descriptor Dn describes the file pointer to the audio data and the index number. The track descriptor Dm describes the file pointer to the audio data and the index number. As a result, a song M1 of one track of an audio file is apparently divided into songs M11 and M12 of two tracks.

When the track n and the track n+1 are connected on the play order table, a track descriptor number Dn that describes information of the track n is obtained from the track information TINFn of the play order table. In addition, a track descriptor number Dm that describes information of the track n+1 is obtained from the track information TINFn+1 of the play order table. All valid values (track descriptor numbers) after the track information TINFn+1 of the play order table are decreased by 1 each.

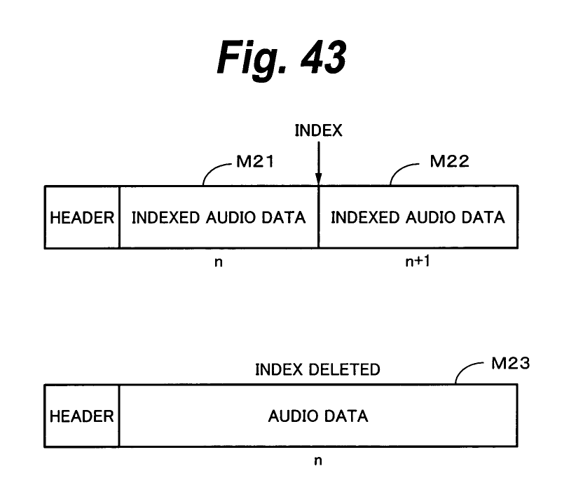

When the track n and the track n+1 are contained in the same audio data file and divided by the index, as shown in FIG. 43, by deleting index information of the header, the tracks can be connected. Thus, songs M21 and M22 of two tracks are connected. As a result, a song M23 of one track is obtained.

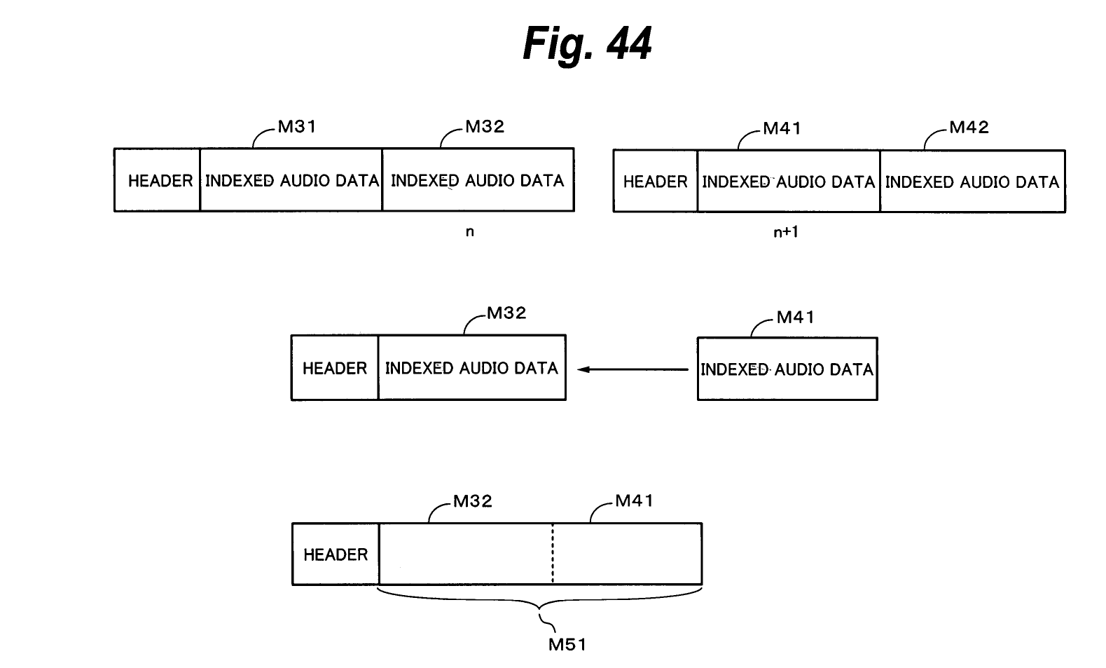

When the track n is a second half of which one audio data file is divided by the index and the track n+1 is a first half of which another audio data file is divided by the index, as shown in FIG. 44, a header is added to data of the track n divided by the index. As a result, an audio data file of a song M32 is created. The header of the audio data file of the track n+1 is removed. The audio data file of the song M32 and the audio data of the track n+1 of the song M41 are connected. As a result, the songs M32 and M41 of two tracks are connected as a song M51 of one track.

To accomplish the foregoing process, a function for adding a header to a track divided by an index, encrypting the track with another encryption key, and converting the indexed audio data into one audio data file and a function for removing a header from an audio data file and connecting the audio data file to another audio data file are provided.

8. Operation when Connected to Personal Computer

To allow the next generation MD1 and the next generation MD2 to have affinity with a personal computer, they uses the FAT system as a data managing system. Thus, the disc of the next generation MD1 system and the disc of the next generation MD2 system can deal with not only audio data, but data that is read and written by a personal computer.

Since the disc drive device 1 reproduces audio data from the disc 90 while reading the audio data therefrom. In particular, in consideration of accessibility of the portable disc drive device 1, it is preferred that the audio data should be sequentially recorded on the disc. In contrast, the personal computer allocates a blank area of the disc and writes data thereto without consideration of sequence of data.

In the recording and reproducing apparatus according to the embodiment of the present invention, the personal computer 100 and the disc drive device 1 are connected with the USB hub 7. When data is written from the personal computer 100 to the disc 90 loaded into the disc drive device 1, the data is written under the control of the file system of the personal computer. In contrast, audio data is written under the control of the file system of the disc drive device 1.

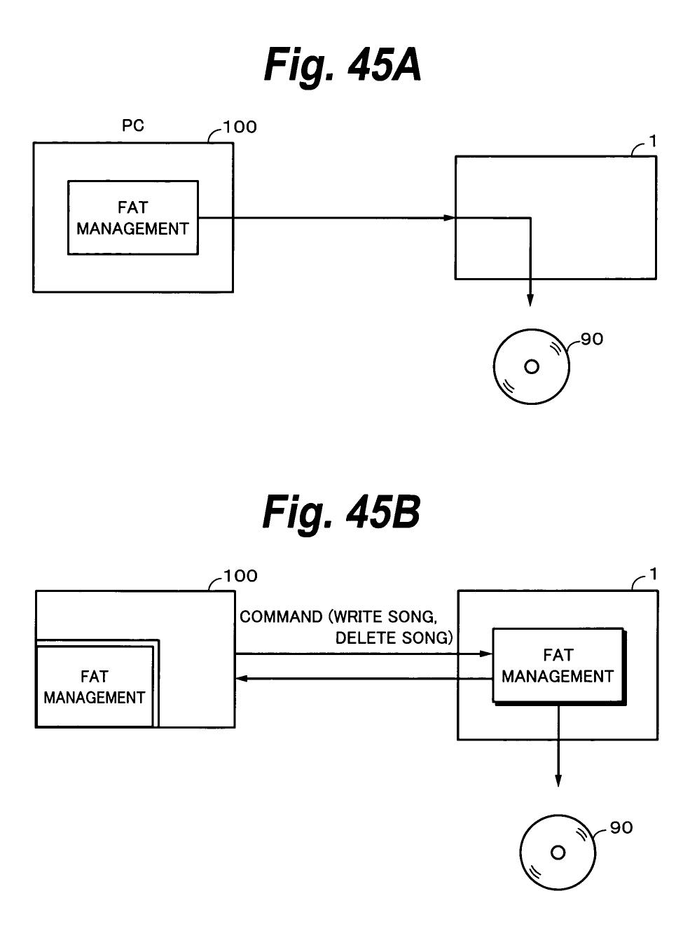

FIG. 45A and FIG. 45B are schematic diagrams describing that a management right is transferred depending on the type of data that is written in the state that the personal computer 100 and the disc drive device 1 are connected with the USB hub 7 (not shown). FIG. 45A shows an example of which computer data is transferred from the personal computer 100 to the disc drive device 1 and recorded to the disc 90 loaded thereinto. In this case, the personal computer 100 manages data on the disc 90 in accordance with the FAT file system.

In this example, it is assumed that the disc 90 is a disc that has been formatted in one of the next generation MD1 system and the next generation MD2 system.

In other words, the personal computer 100 handles the disc drive device 1 connected thereto as if the personal computer manages one removable disc. Thus, the personal computer 100 can read and write data from and to the disc 90 as if the personal computer 100 reads and writes data from and to a flexible disc.

The file system of the personal computer 100 can be provided as a function of an operating system (OS), which is basic software, installed on the personal computer 100. As well known, the OS is recorded as a predetermined program file in for example a hard disk drive of the personal computer 100. When the personal computer 100 gets started, it reads the program file and executes it. As a result, the personal computer 100 can use various functions of the OS.

FIG. 45B shows an example of which audio data is transferred from the personal computer 100 to the disc drive device 1 and the audio data is recorded on the disc 90 loaded into the disc drive device 1. In the personal computer 100, audio data is recorded in a recording medium such as a hard disk drive (HDD).

In addition, it is assumed that utility software has been installed in the personal computer 100. The utility software causes audio data to be encoded in accordance with the ATRAC compression-encoding method and the disc drive device 1 to write audio data to the loaded disc 90 and delete audio data from the disc 90. In addition, the utility software has a function for referencing a track index file of the disc 90 of the disc drive device 1 and browsing track information recorded on the disc 90. The utility software is recorded as a program file to the HDD of the personal computer 100.

For example, the case that audio data recorded on a recording medium of the personal computer 100 is recorded on the disc 90 loaded into the disc drive device 1 will be described. It is assumed that the foregoing utility software has been activated.

First of all, the user operates the personal computer 100 so that predetermined audio data (audio data A) recorded in the HDD is recorded on the disc 90 loaded into the disc drive device 1. According to the operation, the utility software causes the personal computer 100 to output a write request command to the disc drive device 1. The writ request command causes the disc drive device 1 to record the audio data on the disc 90. The write request command is sent from the personal computer 100 to the disc drive device 1.

Thereafter, the audio data A is read from the HDD of the personal computer 100. The foregoing utility software causes the personal computer 100 to perform the ATRAC compression encoding process for the audio data A so as to convert the audio data A into ATRAC compression data. The ATRAC compression data is sent from the personal computer 100 to the disc drive device 1.

When the disc drive device 1 receives a write request command from the personal computer 100, it transfers the audio data A that has been converted into the ATRAC compression data to the disc drive device 1 so as to record the transferred data as audio data to the disc 90.

The disc drive device 1 receives the audio data A from the personal computer 100 through the USB hub 7 and sends the received audio data A to the medium drive portion 2 through the USB interface 6 and the memory transfer controller 3. When the audio data A is sent to the medium drive portion 2, the system controller 9 controls the audio data A so that it is written to the disc 90 in accordance with the FAT management method of the disc drive device 1. In other words, the audio data A is successively written to the disc 90 with a minimum recording length of four recording blocks, namely 64 kbytes×4, in accordance with the FAT system of the disc drive device 1.

Until data has been written to the disc 90, data, a status, and a command are exchanged between the personal computer 100 and the disc drive device 1 in accordance with a predetermined protocol. At that point, the disc drive device 1 side controls a data transfer rate so that an overflow or an underflow does not take place in a cluster buffer 4 on the disc drive device 1 side.

As examples of commands that the personal computer 100 side can use, there is a delete request command as well as the foregoing write request command. The delete request command causes the disc drive device 1 to delete audio data from the disc 90 loaded into the disc drive device 1.

When the personal computer 100 and the disc drive device 1 are connected and the disc 90 is loaded into the disc drive device 1, the foregoing utility software causes the disc drive device 1 to read a track index file from the disc 90 and send the data that has been read the disc 90 to the personal computer 100. The personal computer 100 can display a list of titles of audio data recorded on the disc 90 in accordance with the data that has been read from the track index file.

When audio data (audio data B) is deleted from the list of titles displayed, the personal computer 100 sends information that represents the audio data B to be deleted to the disc drive device 1 along with a delete request command. When the disc drive device 1 receives the delete request command from the personal computer 100, the disc drive device 1 deletes the requested audio data B from the disc 90.

Since audio data is deleted in accordance with the FAT system of the disc drive device 1, audio data of a jumbo file of which a plurality of tracks of audio data is grouped as one file may be deleted as described with reference to FIG. 32A and FIG. 32B.

9. Copy Restriction of Audio Data Recorded on Disc

To protect copyright of audio data recorded on the disc 90, it is necessary to restrict a copy of audio data recorded on the disc 90 to another recording medium and so forth. It is assumed that audio data recorded on the disc 90 is transferred from the disc drive device 1 to the personal computer 100 and recorded to the HDD or the like of the personal computer 100.

In this example, it is assumed that the disc 90 is a disc that has been formatted in accordance with the next generation MD1 system or the next generation MD2 system. In addition, it is assumed that a check-out operation and a check-in operation that will be described later are performed under the control of the foregoing utility software installed on the personal computer 100.

As shown in FIG. 46A, audio data 200 recorded on the disc 90 is moved to the personal computer (PC) 100. “move” represents a sequence of operations of which objective audio data 200 is copied to the personal computer 100 and the original audio data 200 is deleted from the original recording medium (disc 90). In other words, when audio data is “moved”, the data is deleted from the source and the data is transferred to the destination.

An operation of which data is copied from a recording medium to another recording medium and a copy permission right value that represents the number of times a copy operation can be preformed for the same data is decreased by 1 is referred to as check-out. On the other hand, an operation of which data that has been checked out is deleted from the check-out side and the copy permission right value of the check-out side is increased by 1 is referred to as check-in.

When the audio data 200 is moved to the personal computer 100, the audio data 200 is moved (as audio data 200′) to a recording medium, for example a HDD, of the personal computer 100. The audio data 200 is deleted from the original disc 90. As shown in FIG. 46B, the personal computer 100 sets a check-out (CO) permission (or predetermined) value 201 to the moved audio data 200′. In this example, the check-out permission value 201 is set to 3 as denoted by black circles. In other words, the audio data 200′ can be checked out to external recording mediums by the check-out permission value that has been set by the personal computer 100.

In this case, if the audio data 200 that has been checked out is deleted from the original disc 90, the user may be inconvenient. Thus, the audio data 200′ that has been checked out by the personal computer 100 is written back to the disc 90.

When the audio data 200′ is written back from the personal computer 100 to the original disc 90, as shown in FIG. 46C, the check-out permission value is decreased by one. Thus, the check-out permission value becomes (3−1=2). At that point, since the check-out permission value of the audio data 200′ recorded in the personal computer 100 is 2, the audio data 200′ is not deleted from the personal computer 100. In other words, the audio data 200′ recorded in the personal computer 100 is copied to the disc 90 and audio data 200″ that has been copied from the audio data 200′ is recorded on the disc 90.

The check-out permission value 201 is managed in accordance with copyright management information of a track scripter of the track information table (see FIG. 27B). Since each track has a track descriptor, the check-out permission value 201 can be set to each track (music data). A track descriptor copied from the disc 90 to the personal computer 100 is used as control information of audio data moved to the personal computer 100.

When audio data is moved from the disc 90 to the personal computer 100, a track descriptor corresponding to the moved audio data is copied to the personal computer 100. The personal computer 100 manages the audio data moved from the disc 90 in accordance with the track descriptor. When the audio data is moved and recorded to the HDD or the like of the personal computer 100, the check-out permission value 201 of the copyright management information of the track descriptor is set to a predetermined value (in this example, 3).

As copyright management information, a unit ID that identifies a check-out source device and a content ID that identifies a checked-out content (audio data) are managed along with the foregoing check-out permission value 201. In the process shown in FIG. 46C, the device ID of the copy destination device is authenticated in accordance with the unit ID of the copyright management information corresponding to audio data to be copied. When the device ID of the copyright management information is different from the device ID of the copy destination device ID, a copy operation can be prohibited.

In the check-out process shown in FIG. 46A to FIG. 46C, audio data recorded on the disc 90 is temporarily moved to the personal computer 100 and then written back from the personal computer 100 to the disc 90. Thus, the user should perform a complicated operation. In addition, since the user should wait until the audio data is read from the disc 90 and the audio data is written back to the disc 90, he or she may feel that he or she spends long time. In addition, the user may not like audio data to be temporarily deleted from the disc 90.

To solve such a problem, when audio data recorded on the disc 90 is checked out, assuming that the foregoing intermediate process has been performed, a process for obtaining only the result shown in FIG. 46C is performed. Next, an example of such a process will be described. The following process is executed by a user's command such as “Check out audio data xx recorded on the disc 90.”

(1) Audio data recorded on the disc 90 is copied to the HDD of the personal computer 100. In addition, the audio data recorded on the disc 90 is deleted by invalidating a part of management data of the audio data. For example, link information TINFn to a track descriptor corresponding to the audio data is deleted from the play order table. In addition, link information PINFn to a track descriptor corresponding to the audio data is deleted from the programmed file order table. Alternatively, a track descriptor itself corresponding to the audio data may be deleted. Thus, the audio data of the disc 90 is prohibited from being used. As a result, the audio data is moved from the disc 90 to the personal computer 100.

(2) At step (1), when the audio data is copied to the personal computer 100, the track descriptor corresponding to the audio data is also copied to the HDD of the personal computer 100.

(3) Thereafter, the personal computer 100 sets the check-out permission value of the copyright management information of the track descriptor corresponding to the audio data copied and moved from the disc 90 to a predetermined value for example 3.

(4) Thereafter, the personal computer 100 obtains a content ID of the moved audio data in accordance with the track descriptor that has been copied from the disc 90 and records the content ID as a content ID that represents audio data that can be checked in.

(5) Thereafter, the check-out permission value of the copyright management information of the track descriptor corresponding to audio data that has been moved to the personal computer 100 is subtracted from the value that has been set at step (3) by 1. In this example, the check-out permission value becomes (3−1=2).

(6) Next, a track descriptor corresponding to the audio data moved to a disc drive device 1 (not shown) into which the disc 90 is loaded is validated. For example, when the link information TINFn and PINFn that have been deleted at step (1) are restored or restructured, the track descriptor corresponding to the audio data is validated. When the track descriptor corresponding to the audio data is deleted at step (1), the track descriptor is restructured. The track descriptor recorded in the personal computer 100 may be transferred to the disc drive device 1 and recorded to the disc 90.

After steps (1) to (6) have been completed, it is assumed that the check-out process has been completed. Thus, audio data can be copied from the disc 90 to the personal computer 100 while copyright of the audio data is protected and the user's operation can be simplified.

It is preferred that the copy operation of audio data preformed at steps (1) to (6) should be applied to audio data that the user records to the disc 90 with the disc drive device 1.

When audio data that has been checked out is checked in, the personal computer 100 searches for audio data and control information for example copyright management information of a track descriptor, performs a determination in accordance with the searched audio data and control information, and checks in the audio data.

In the foregoing, the disc systems according to the present invention have been described. Next, a content distributing system according to an embodiment of the present invention will be described. FIG. 47 shows an example of the structure of the content distributing system according to the embodiment of the present invention.

A disc production plant 202 produces the disc 90 of the next generation MD2 system. A BAC baking device 203 bakes a disc ID to the BCA of the disc 90. The disc ID baked in the BCA is a recording medium identifier unique to the disc 90 as a recording medium. According to the embodiment, the above-described UID is used as the disc ID. The UID may be for example EUI-64 (http://standards.ieee.org/regauth/oui/tutorials/EUI64. html). In the following description, it is assumed that the disc of the next generation MD2 system having the BCA is the disc 90 having the disc ID. However, it should be noted that the disc of the next generation MD 1.5 system and the disc of the next generation MD1 system can be used as the disc 90 having the disc ID.

In the production process for the disc 90, the disc production plant 202 bakes the disc ID to the BCA of the disc 90 using the BAC baking device 203. As described above, the BCA has a capacity of 188 bytes that is sufficient for an ID. The consumer type disc drive device 1 cannot write the disc ID to the BCA. It is assured that the disc ID baked in the BCA has not been forged in the format of the next generation MD2 system. Thus, it is assured that the disc ID is unique when the disc 90 is shipped from the disc production plant 202.

The disc production plant 202 ships produced discs 90 having the disc ID to a service body 204 along with a list of disc IDs.

The service body 204 is a general term of various types of service providers that sell the discs 90 and distribute contents. The service body 204 has a content distributing server 205 that performs a process for distributing a content to a user 206. The content distributing server 205 can be connected to a network such as the Internet. The content distributing server 205 comprises a right server 205a, a content server 205b, and a buddy server 205c. The right server 205a, the content server 205b, and the buddy server 205c may be independently or integrally managed by the service body 204 as long as they are connected through the network and exchange information thereamong.

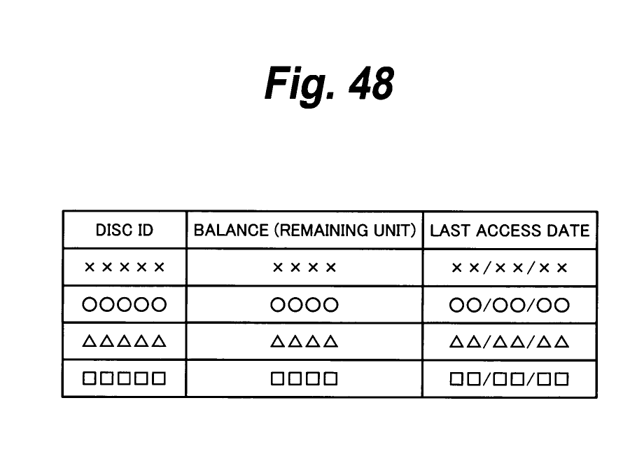

The right server 205a manages right of the disc 90 in accordance with a right table. FIG. 48 shows an example of the right table. As shown in FIG. 48, the right table correlatively manages charging information of each disc 90, balance of deposit as prepaid information, and the disc ID that identifies each disc 90. As shown in FIG. 48, other items such as last access date and disc ID may be correlatively managed. With the last access date field, the right table can be easily managed.

The prepaid information may be distribution permission content, distribution permission value, expiration, check-out permission value, and so forth as well as distribution deposit. It should be noted that post-paid information such as distributed content fee can be used instead of pre-paid information of charging information.

When pre-paid information is used as charging information, the service body 204 restricts distribution of a content to the user 206 in accordance with the pre-paid information. When post-paid information is used as charging information, the service body 204 settles the account according to the information using a credit card, bank transfer, electronic money, or the like.

The content server 205b manages contents such as music data and video data that are distributed and information about the contents such as distribution fees of contents.

The buddy server 205c manages a buddy table. The buddy table according to the embodiment of the present invention is a table that correlates the disc ID as a first recording medium identifier that identifies the disc 90 that the information provider side user has and the disc ID that is a second recording medium identifier that identifies the disc 90 that the information recipient side user has.

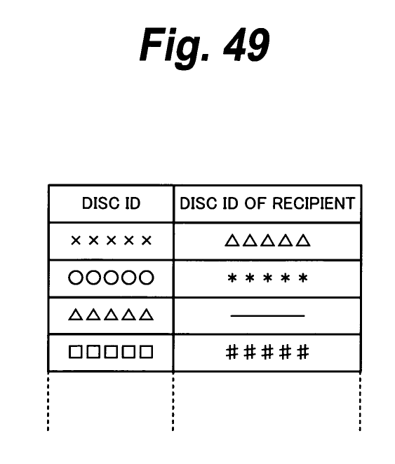

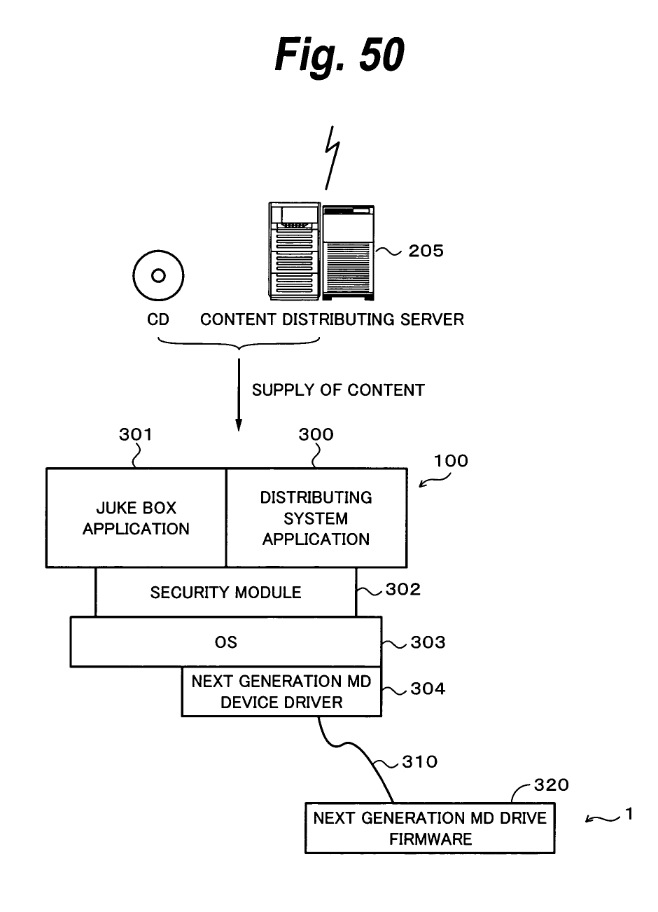

FIG. 49 shows an example of the buddy table. According to the embodiment, when the personal computer 100 of the user 206 side logs in the content distributing server 205, the disc ID is used. Thus, as shown in FIG. 49, when the disc ID (first recording medium identifier) and the disc ID (second recording medium identifier) of the information recipient side are correlatively registered, information about the disc ID of the information provider side can be supplied to the user who has logged in the content distributing server 205 with the disc ID of the information recipient side.

The service body 204 registers the disc ID of the list received from the disc production plant 202 to the content distributing server 205. When the disc 90 is sold as a pre-paid disc, the service body 204 correlatively registers the disc ID and pre-paid information corresponding to for example sales price as charging information of the disc 90 identified by the disc ID to the right table of the right server 205a. When a plurality of discs 90 are sold in the unit of a buddy, the disc ID of the information provider side and the disc ID of the information recipient side are correlatively registered to the buddy table of the buddy server 205c. In this case, the sales price may be discounted.

The service body 204 sells to the user 206 the disc 90 whose disc ID has been registered to the content distributing server 205. The user 206 connects the personal computer 100 to the content distributing server 205 through a network such as the Internet using the disc 90 and receives a content distribution service from the service body 204. Contents are distributed from the content distributing server 205 to the personal computer 100 as a terminal unit. When the disc drive device 1 has a function of the personal computer 100 as will be described later, the disc drive device 1 can be used as a terminal unit. It should be noted that there are a plurality of users 206, disc drive devices 1, and personal computers 100.

Next, software according to the present invention will be described. FIG. 50 shows the structure of the software that the user 206 uses for the content distributing system according to the embodiment of the present invention.

A distributing system application 300 and a juke box application 301 are installed in the personal computer 100. The distributing system application 300 provides a user interface with which a content is downloaded from the content distributing server 205 through a network such as the Internet.

As log-in information with which the personal computer 100 is connected to the content distributing server 205, the disc ID of the disc 90 loaded into the disc drive device 1 is used. The disc drive device 1 may be connected to the content distributing server 205 under the control of the distributing system application 300. Alternatively, the content distributing server 205 may be connected to the content distributing server 205 under the control of the distributing system application 300 in association with the juke box application 301. Alternatively, when the disc 90 is loaded into the disc drive device 1, it may automatically log-in the content distributing server 205.

The juke box application 301 provides a user interface that allows contents ripped from compact discs (CDs) and/or obtained from a network through the network using the distributing system application 300 to be stored as a library and the library to be operated. In addition, the juke box application 301 controls connection of the personal computer 100 and the disc drive device 1. The function of the utility software may be contained in the juke box application 301. Alternatively, the distributing system application 300 and the juke box application 301 may be integrated as one application.

The personal computer 100 operates the distributing system application 300 and the juke box application 301 on an OS 303 through a security module 302. The security module 302 has a license compliance module (LCM) prescribed in Secure Digital Music Initiative (SDMI). The LCM causes the juke box application 301 and the disc drive device 1 to perform an authenticating process therebetween. The security module 302 also checks conformity of the content ID and the UID. Contents are exchanged between the applications such as the distributing system application 300 and the juke box application 301 and the disc drive device 1 through the security module 302.

On the other hand, the disc drive device 1 is provided with next generation MD drive firmware 320 as software that serves to control the operation of the disc drive device 1. When the disc drive device 1 is controlled by the personal computer 100 and data is exchanged between the personal computer 100 and the disc drive device 1, a communication is performed between the next generation MD drive firmware 320 and the OS 303 through a next generation MD device driver 304.

The personal computer 100 side can upgrade the version of the next generation MD drive firmware 320 through a predetermined cable 310 that connects the personal computer 100 and the disc drive device 1.

Applications such as the distributing system application 300 and the juke box application 301 are supplied with a recording medium such as a compact disc-read only memory (CD-ROM). When the recording medium is loaded into the personal computer 100 and a predetermined operation is performed for the personal computer 100, the applications of the distributing system application 300, the juke box application 301, and so forth are stored in for example a hard disk drive of the personal computer 100. Alternatively, the applications of the distributing system application 300, the juke box application 301, and so forth (or application installer) may be downloaded to the personal computer 100 through a network such as the Internet.

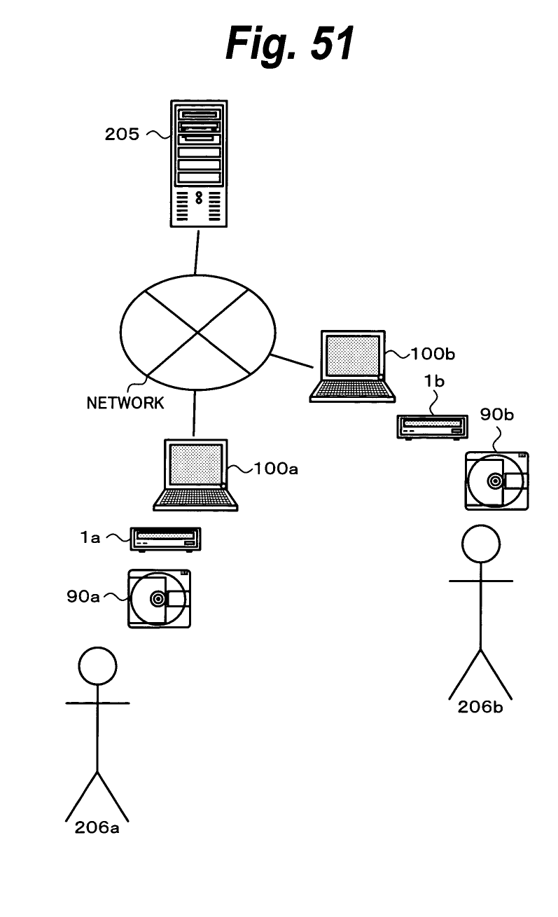

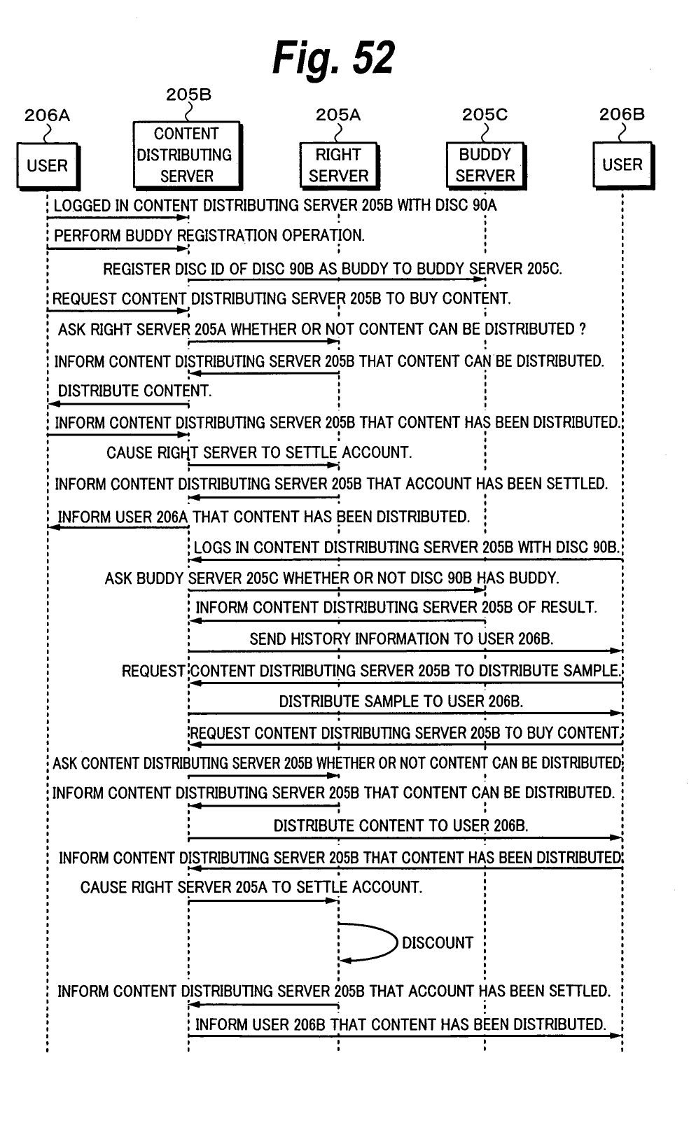

Next, with reference to FIG. 51 and FIG. 52, an example of the use of the content distributing system according to the embodiment of the present invention will be described. FIG. 51 shows an example of the structure of an information provider side and an information recipient side. FIG. 52 is a diagram showing a process performed in the case that a pre-paid disc is used for the disc 90 according to the embodiment of the present invention.

As shown in FIG. 51, a user 206a has a personal computer 10a, a disc drive device 1a, and a disc 90a. A user 206b has a personal computer 10b, a disc drive device 1b, and a disc 90b. The disc drive device 1a of the user 206a is connected to the personal computer 10a. The disc drive device 1b of the user 206b is connected to the personal computer 100b through a USB or the like.

The personal computer 100a and the personal computer 100b can be connected to a network such as the Internet. In addition, the foregoing content distributing server 205 is connected to the network. In the example, the content server 205b also operates as a log-in server that exchanges data with users.

The user 206a as an information provider side pre-obtains a disc ID of the disc 90b that the user 206b as an information recipient side uses. The disc ID of the disc 90b is read as information of the BCA from the disc 90b loaded into the disc drive device 1a of the user 206a and recorded in a recording medium such as a hard disk drive of the personal computer 10a so that the disc ID of the disc 90b can be read by the distributing system application 300. The user 206a buys the disc 90b, obtains the disc ID thereof, and gives it to the user 206a. Alternatively, the user 206a may borrow the user ID from the user 206b.

When the user 206a has obtained the disc ID of the disc 90b, as shown in FIG. 52, he or she loads the disc 90a into the disc drive device la connected to the personal computer 100a and logs in the content server 205b through the distributing system application 300. After the personal computer 10a has logged in the content server 205b, the user 206a performs a predetermined operation so as to request the content server 205b to register the disc ID of the disc 90b stored in the personal computer 100a as a buddy.

The content server 205b sends the disc ID of the disc 90a with which the user 206 who has logged in the content server 205b and the disc ID of the disc 90b requested to be registered as a buddy to the buddy server 205c. The buddy server 205c correlatively registers the disc IDs so that the disc 90a becomes an information provider side and the disc 90b becomes an information recipient side. As a result, the registration of the buddy is completed. Alternatively, as described above, if the service body 204 pre-registers a buddy, when the disc 90a and the disc 90b are sold as a set to the user 206a, he or she can omit the buddy registration operation.

The user 206a performs a predetermined operation so as to request the content server 205b to buy his or her desired content. The content server 205b sends the disc ID of the disc 90a and necessary information such as a distribution fee for the requested content to the right server 205a and asks whether or not the content requested by the user 206a can be distributed to the disc 90a.

The right server 205a references the right table, extracts the balance of the distribution deposit of the disc 90a from the right table in accordance with the disc ID that identifies the disc 90a, compares the balance with the distribution fee of the requested content, and determines whether or not the requested content can be distributed. When the pre-paid information is not the distribution deposit, the right server 205a compares information corresponding to the pre-paid information with the information of the right table. Alternatively, the content server 205b may determine whether or not the requested content can be distributed. The right server 205a sends the determined result to the content server 205b.

When the determined result represents that the requested content can be distributed, the content server 205b informs the user 206a of that through the personal computer 100a.

When the determined result represents that the requested content can be distributed, the content server 205b distributes the requested content to the personal computer 10a of the user 206a. When the content has been normally downloaded, the personal computer 100a informs the content server 205b of that. After the content server 205b has been informed that the content had been normally distributed, the content server 205b causes the right server 205a to settle the account.

When the right server 205a has been caused to settle the account, the right server 205a updates the right table in accordance with the distributed content. When the pre-paid information is a distribution deposit, the right server 205a subtracts the distribution fee of the distributed content from the balance of the distribution deposit corresponding to the disc ID of the disc 90a. The right server 205a informs the content server 205b that the account settlement has been completed. The content server 205b informs the personal computer 10a of the user 206a that the content has been distributed. In addition, the content server 205b correlates the distributed content information with the disc ID of the disc 90a and records them as content distribution history information. As a result, the user 206a has bought a content with the disc 90a.

Thereafter, the user 206b as the information recipient side loads the disc 90b into the disc drive device 1b connected to the personal computer 100b and causes the personal computer 100b to log in the content server 205b through the distributing system application 300.

The content server 205b asks the buddy server 205c whether or not the disc 90b has a buddy, namely a disc 90 to which information is provided. The buddy server 205c references the buddy table and determines whether or not there is a disc ID associated with the disc ID of the disc 90b. The buddy server 205c sends the determined result to the content server 205b.

When the determined result represents that there is no disc ID associated with the disc ID of the disc 90b, for example the content server 205b informs the user 206a of the determined result through the personal computer 100a and performs the regular content distributing process.

In this case, the determined result represents that there is a disc ID associated with the disc ID of the disc 90b. The content server 205b sends the corresponding disc ID to the personal computer 100b of the user 206b, namely content distribution history information to the user 206a who has logged in the content server 205b with the disc ID of the disc 90a.

The user 206b references the content distribution history information of the user 206a and buys a content. The user 206b selects his or her favorite content from the history information with the personal computer 100b and requests the content server 205b to obtain sample information thereof. The content server 205b distributes the sample information to the personal computer 100b of the user 206b. The sample information can be easily distributed with history information linked to samples of contents.

The user 206b reproduces the distributed sample. When the user 206b likes the content, he or she requests the content server 205b to buy the content through the personal computer 100b. The content server 205b sends the disc ID of the disc 90b and necessary information such as the distribution fee and so forth of the requested content to the right server 205a and asks it whether or not the requested content can be distributed to the disc 90b.

The right server 205a references the right table, extracts the balance of the distribution deposit of the disc 90b corresponding to the disc ID of the disc 90b, compares the balance with the distribution fee of the requested content, and determines whether or not the requested content can be distributed. When the pre-paid information is other than the distribution deposit, the right server 205a compares information corresponding to the pre-paid information with the information of the right table. Alternatively, the content server 205b may determine whether the requested content can be distributed. The right server 205a sends the determined result to the content server 205b.

When the determined result represents that the requested content cannot be distributed, the content server 205b informs the user 206b of the determined result through the personal computer 100b.

When the determined result represents that the requested content can be distributed, the content server 205b distributes the requested content to the personal computer 100b of the user 206b. After the content has been correctly downloaded, the personal computer 100b informs the content server 205b that the content has been distributed. After the content server 205b has been informed that the content had been distributed, the content server 205b causes the right server 205a to settle the account.

After the right server 205a has been caused to settle the account, the right server 205a updates the right table corresponding to the distributed content. When the pre-paid information is a distribution deposit, the right server 205a subtracts the distribution fee of the content from the balance of the distribution deposit corresponding to the disc ID of the disc 90a. At that point, if the user 206a has recommended the user 206b to buy a content from the distributing system, a benefit such as a discount price may be given to the user 206b. In addition, the same benefit may be given to the user 206a. The right server 205a informs the content server 205b that the account settlement has been completed. When the content server 205b has been informed of that, the content server 205b informs the personal computer 100b that the contents has been distributed. As a result, the user 206a has bought the content with the disc 90a.

As described above, according to the embodiment of the present invention, the personal computer 100 obtains the disc ID from the disc 90 loaded into the disc drive device 1. The personal computer 100 is connected to the content distributing server 205 through a network using the obtained disc ID. Thus, the user does not need to register himself or herself to the content distributing server 205. Thus, the user 206 can easily use the content distributing service without a risk of which information such the address, name, and so forth of the user 206 leaks out.

In addition, the buddy server 205c correlatively registers the disc ID of the disc 90a that the user 206a as the information provider side uses in the log-in operation and the disc ID of the disc 90b that the user 206b as the information recipient side uses in the log-in operation to the buddy table. In addition, the content distributing server 205b correlatively records disc IDs and content distribution history information. As a result, when the user 206b logs in the content distributing server 205b with the disc 90b of the information recipient side, the content distribution history information corresponding to the disc ID of the disc 90a as the information provider side correlated with the disc ID of the disc 90b as the information recipient side can be securely sent to the personal computer 100b of the information recipient side. Thus, information about a content can be easily exchanged between the user 206a and the user 206b. The service body 204 can promote the distribution of the content.

In addition, the right server 205a manages the right table that correlates pre-paid information and the disc ID corresponding to each disc. The right server 205a references the disc ID with which the content distributing server 205 is logged in and the right table. When the content can be distributed, the right server 205a distributes the content to the personal computer 100 and updates the pre-paid information. As a result, the payment operation for the content can be simplified. Thus, the user 206 can easily request the content distributing server 205 to distribute a content.

When the service body 204 sells a pair of the disc 90a as an information provider side and the disc 90b as an information recipient side and pre-registers disc IDs thereof to the buddy table, the user 206a can omit a buddy registration operation. When the disc drive device la records the disc ID of the disc 90b loaded thereinto and the personal computer 100a can use the disc 90b, the user 206a can obtain the disc ID of the disc 90b as the information recipient side in any place that he or she has carried the disc drive device 1a.

When the user 206b selects a content from the content distribution history information of the user 206a and receives the selected content from the content distributing server 205b, distribution of contents can be easily synchronized between the user 206a and the user 206b. When the user 206b selects a content from the content distribution history information of the user 206a and receives the selected content from the content distributing server 205b, if a benefit such as a discount of the distribution fee may be given to the user 206b, the use rate of the system of the users 206 is improved. As a result, the service body 204 can promote the distribution of the content.

Just inserting the disc 90 into the disc drive device 1, the user can automatically log in the content distributing server 205 and easily share a content with a particular user.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention. According to the foregoing embodiment, as the disc 90, which is a recording medium used to log in the content distributing server 205, MDs having a unique identifier, for example the disc of the next generation MD1 system and the disc of the next generation MD2 system, were described. However, the present invention is not limited to such examples. Instead, the present invention can be applied to for example an optical disc, a magnetic disc, a magnetic tape, or a memory card that has a unique identifier.

In addition, according to the foregoing embodiment, the history information supplied to the user 206b is information of contents distributed to the user 206a. Alternatively, the history information may be other information such as contents that have been referenced or information associated therewith.

1. A content distributing system for distributing a content from a content distributing server to a terminal unit,
wherein the terminal unit is configured to obtain a recording medium identifier from a recording medium, the recording medium identifier being unique to each recording medium, and
wherein the content distributing server comprises:
managing means for correlatively managing charging information and the recoding medium identifier of each recording medium;
registering means for correlatively registering a first recording medium identifier identifying a recording medium of an information provider side and a second recoding medium identifier identifying a recording medium of an information recipient side;
content distributing means for distributing a content to the terminal unit and updating the charging information; and
recording means for correlatively recording the recording medium identifier used to connect the terminal unit and the content distributing server and history information of the content that has been distributed by the content distributing means,
wherein when the recording medium identifier that is used to connect the terminal unit and the content distributing server is the second recording medium identifier, the content distributing server provides the history information corresponding to the first recording medium identifier correlated with the second recording medium identifier to the terminal unit.

2. The content distributing system as set forth in claim 1,
wherein a recording medium on the information provider side and a recording medium on the information recipient side are sold as a pair, before the recording medium on the information provider side and the recoding medium on the information recipient side are sold, they are registered by the registering means.

3. The content distributing system as set forth in claim 1,
wherein before the terminal unit is connected to the content distributing server, the terminal unit is configured to record the second recoding medium identifier, and
wherein when the terminal unit is connected to the content distributing server with the first recording medium identifier, the registering means is configured to register the first recoding medium identifier with the second recording medium identifier that has been recorded in the terminal unit.

4. The content distributing system as set forth in claim 1,
wherein sample information is provided along with the history information.

5. The content distributing system as set forth in claim 1,
wherein when the terminal unit is connected to the content distributing server with the second recoding medium identifier, a content that is bought can be selected from the history information.

6. The content distributing system as set forth in claim 5,
wherein when a content that is bought is selected from the history information, a benefit can be obtained.

7. The content distributing system as set forth in claim 1,
wherein the terminal unit and the content distributing server are connected with the recording medium identifier obtained by the terminal unit through a network.

8. A content distributing method for distributing a content from a content distributing server to a terminal unit, the terminal unit being configured to obtain a recording medium identifier from a recording medium, the recording medium identifier being unique to each recording medium, the content distributing server comprising:
managing means for correlatively managing charging information and the recoding medium identifier of each recording medium;
registering means for correlatively registering a first recording medium identifier identifying a recording medium of an information provider side and a second recoding medium identifier identifying a recording medium of an information recipient side;
content distributing means for distributing a content to the terminal unit and updating the charging information; and
recording means for correlatively recording the recording medium identifier used to connect the terminal unit and the content distributing server and history information of the content that has been distributed by the content distributing means,
the content distributing method comprising the step of:
when the recording medium identifier that is used to connect the terminal unit and the content distributing server is the second recording medium identifier, causing the content distributing server to provide the history information corresponding to the first recording medium identifier correlated with the second recording medium identifier to the terminal unit.

9. A content distributing server for distributing a content to a terminal unit, comprising:
managing means for correlatively managing charging information and a recoding medium identifier of each recording medium;
registering means for correlatively registering a first recording medium identifier identifying a recording medium of an information provider side and a second recoding medium identifier identifying a recording medium of an information recipient side;
connecting means for connecting the terminal unit to the content distributing server with a recording medium identifier obtained from a recording medium by the terminal unit;
content distributing means for distributing a content to the terminal unit and updating charging information; and
recording means for correlatively recording the recording medium identifier used by the connecting means and history information of the content that has been distributed by the content distributing means,
wherein when the recording medium identifier used by the connecting means is the second recording medium identifier, the history information corresponding to the first recording medium identifier correlated with the second recording medium identifier by the registering means to the terminal unit.

10. The content distributing server as set forth in claim 9,
wherein sample information is provided along with the history information.

11. The content distributing server as set forth in claim 9,
wherein when the terminal unit is connected to the content distributing server with the second recoding medium identifier, a content that is bought can be selected from the history information.

12. A terminal unit for receiving a content from a content distributing server, comprising:
connecting means for obtaining a recording medium identifier from a recording medium and connecting the terminal unit to the content distributing server with the obtained recording medium identifier, the recording medium identifier being unique to each recording medium,
wherein information about the recording medium identifier is received from the content distributing server.

13. The terminal unit as set forth in claim 12,
wherein when the terminal unit is connected to the content distributing server by the connecting means, a recording medium identifier that is different from a pre-recorded recording medium identifier is sent to the content distributing server.
